(19) United States
(12) Patent Application Publication
(10) Pub. No.: US 2009/0046623 A1
(43) Pub. Date: Feb. 19, 2009

(54) Network repay device, network relay program, and storage medium containing the network relay program

(76) Inventors: Minoru Takemoto, Chiba-shi (JP); Toru Ueda, Soraku-gun (JP)

Correspondence Address: BIRCH STEWART KOLASCH & BIRCH, PO BOX 747, FALLS CHURCH, VA, 22040-0747, US

(21) Appl. No.: 12/285,162

(22) Filed: Sep. 30, 2008

Related U.S. Application Data
(63) Continuation of application No. 10/535,239, filed on May 17, 2005.

(30) Foreign Application Priority Data
Nov. 18, 2002 (JP) 2002-334217
Sep. 30, 2003 (JP) 2003-341931

(51) Int. Cl. H04B 7/14

(52) U.S. Cl. 370/315

(57) ABSTRACT

When a communication station receives trigger for a stream to be transmitted or received by the communication station, the communication station determines whether the communication station transmits the stream in a network, and the communication station changes whether the communication station obtains a communications resource of the network from a communications resource management station in accordance with a result of the determination.

This application is a Continuation of co-pending application Ser. No. 10/535,239 filed on May 17, 2005 and for which priority is claimed under 35 U.S.C. § 120. Application Ser. No. 10/535,239 is the national phase of PCT International Application No. PCT/JP03/14666 filed on Nov. 18, 2003 under 35 U.S.C. § 371. The entire contents of each of the above-identified applications are hereby incorporated by reference.

### TECHNICAL FIELD

The present invention relates to a network relay device for relaying between different types of communications networks.

### BACKGROUND ART

In recent years, digitalization in home-AV (Audio/Visual) devices has been promoted. As for television, for example, transition from terrestrial broadcasting to digital has been planed as well as transition from satellite broadcasting to digital. In addition, DVD (Digital Versatile Disc) home theater systems have been widely used. Moreover, with the development of communications infrastructures, broadband Internet connections have been progressed, and such a video distribution that high-quality video data are received through streaming via this broadband Internet has been developed for its practical use.

Thus, under circumstances where various AV devices are provided in a house, demanded is a usage pattern of the AV devices where these AV devices are connected through a network so that they operate in conjunction with each other. In the house, for example, in order to connect various kinds of AV devices located respectively in a plurality of rooms through a network, there increases the need for the use of a wired network realized by an IEEE1394 network, for example, and wireless network realized by wireless LAN, for example. In this case, there arises the need for establishment of a system where plural types of networks are connected to each other.

FIG. 19 is a system structure for connecting between an IEEE1394 wired network and a wireless network which is realized by a wireless LAN. This system is provided with: a video transmission device 101 as a device transmitting videos, such as tuner or DVD player; a video reception device 103 as a device receiving videos, such as liquid crystal display or plasma display; and a wireless gateway 102. The video transmission device 101 and the wireless gateway 102 are connected to each other via the IEEE1394. The wireless gateway 102 and the video reception device 103 are connected to each other via the wireless LAN. A video signal outputted from the video transmission device 101 is transmitted via the IEEE1394 network to the wireless gateway 102, and then transmitted via the wireless LAN to the video reception device 103.

In the system as described above, as a method of establishing a band-secured communication path between the IEEE1394 network and the wireless LAN, for example, Japanese Laid-Open Patent Application No. 2000/224216 (published on Aug. 11, 2000) proposes the following method.

After the video transmission device 101 obtains a band and channel on an IEEE1394 bus, it transmits a packet for band notification to the wireless gateway 102. Similarly, after the wireless gateway 102 obtains a band on the wireless LAN, it transmits a band notification packet to the video reception device 103. The video reception device 103 returns an ACK packet in response to the received band notification packet. The wireless gateway 102, upon receipt of the ACK packet from the video reception device 103, transmits an ACK packet to the video transmission device 101 in the same manner. The above sequence secures a band in a communications path from the video transmission device 101 to the video reception device 103. Subsequently, video signals are transmitted and received.

However, like the above system, in a system where transmission and reception of the band notification packet are carried out among the video transmission device 101, the wireless gateway 102, and the video reception device 103 for securing of a band, it is essential for each device to understand and handle this band notification packet. That is, each device must be additionally provided with a structure for handling the band notification packet. This means that it is impossible to use the conventionally existing video transmission device 101 and video reception device 103 as they are. This puts an enormous load on users, and a smooth proliferation of the system as described above cannot be expected.

The above system includes the wireless network. Communications through the wireless network changes a communications state depending upon environmental changes. For example, nowadays, with the proliferation of a liquid crystal television and the like, the video reception device can be moved easily. Such a movement of the communications station causes a change in communications distance and communications environment. Thus, variations in reliability of communications are expected. That is, in the wireless network, there arises the problem that it is necessary to secure a band in consideration with a property of wireless communications. In the above-mentioned system for communications with the wired network and the wireless network, a method considering such a problem has not been proposed as of now.

In the above system, for example, in the event when the video transmission device 101 is turned power off unexpectedly and when a connection line is cut off physically, communications in the wired network are ceased. Here, on the wired network side, in case of such an event, a band is released. However, on the wireless network side, a band is not released properly since such a disconnection in the communications is unexpected. This causes the problem of a waste of a band.

Moreover, in the above system, there arises the problem that if securing of a band in the IEEE1394 wired network has succeeded, but securing of a band in the wireless network has failed, it is impossible to release a band in the wired network. More specifically, in the IEEE1394 network, only a node having established a connection can release the connection between the nodes, as defined by the IEC61883. Note that, the IEEE1394 normally regards obtaining of a band and connection establishment as a set of operations. That is, the video transmission device 101 obtains a band and channel in the wired network and establishes a connection, whereas the wireless gateway 102 detects a failure in securing of a band in the wireless network. Therefore, the wireless gateway 102 cannot cut off a connection and release the IEEE1394 band and channel.

The present invention has been attained to solve the above problem. An object thereof is to provide a network relay device which enables intercommunications between the communications stations respectively provided on communications networks of different types, without necessity of a special operation by the communications stations.

### DISCLOSURE OF INVENTION

A network relay device according to the present invention is a network relay device connected to a first communications network and a second communications network with which said device can transmit data after securing a communications resource, said device including a first network interface where said device is connected to the first communications network and a second network interface where said device is connected to the second communications network, said device including: an event/state detecting section for detecting an event and/or a state regarding the first communications network via the first network interface; a communications resource determination section for determining a communications resource to be obtained, changed, or released in the second communications network, in accordance with the event and/or the state, regarding the first communications network, detected by the event/state detecting section; and a communications resource management section for obtaining, changing, or releasing a communications resource in the second communications network via the second network interface on the basis of the communications resource calculated by the communications resource determination section.

In the above arrangement, the data detecting section first detects an event and/or state regarding the first communications network. In accordance with the detected event and/or state, the communications resource determination section calculates a communications resource to be obtained, changed, or released in the second communications network. On the basis of the calculated communications resource, the communications resource management section obtains, changes or releases a communications resource in the second communications network.

That is, for example, for data transmission from a data transmitting station on the first communications network to a data receiving station on the second communications network, the data transmitting station first transmits, to the network relay device, a signal indicating that the data transmitting station is going to transmit data. This signal may be a signal normally used in the first communications network, so that it is not necessary for the data transmitting station to perform a special operation.

Then, on the network relay device, the event/state detecting section detects this signal from the data transmitting station as the event regarding the first communications network. On the basis of a calculation result obtained by the communications resource determination section, the communications resource management section obtains a communications resource in the second communications network. In this manner, communications with the data receiving station becomes possible. Here again, it is not necessary for the data receiving station to perform a special operation.

As described above, according to the above arrangement, for communications between communications stations respectively provided in communications network of mutually different types, it is not necessary for both of the communications stations to perform special operations. Therefore, it is possible to use conventional devices as they are. This brings about the effect of allowing the user to easily introduce a wider communications network including communications networks of mutually different types.

For a fuller understanding of the nature and advantages of the invention, reference should be made to the ensuing detailed description taken in conjunction with the accompanying drawings.

### BRIEF DESCRIPTION OF DRAWINGS

FIG. 1 is a block diagram illustrating a schematic structure of a communications network system according to one embodiment of the present invention.

FIG. 2 is a diagram illustrating a message sequence for securing of a band in the communications network system.

FIG. 3 is a block diagram illustrating a schematic structure of a relay station provided in the communications network system.

FIG. 4 is a flowchart of a process flow in a first relay station.

FIG. 5 is a table for explaining how a resource association management section manages association of an IEEE1394 stream with a wireless stream.

FIG. 6 is a block diagram illustrating a schematic structure of a relay station according to another embodiment of the present invention.

FIG. 7 is a flowchart of a process flow in a first relay station according to another embodiment of the present invention.

FIG. 8 is a block diagram illustrating a schematic structure in a relay station according to still another embodiment of the present invention.

FIG. 9 is a flowchart of a process flow in a second relay station according to still another embodiment of the present invention.

FIG. 10 is a block diagram illustrating a schematic structure of a relay station according to yet another embodiment of the present invention.

FIG. 11 is a flowchart of a process flow in a first relay station according to yet another embodiment of the present invention.

FIG. 12 is a block diagram illustrating a schematic structure of a relay station according to further another embodiment of the present invention.

FIG. 13 is a flowchart of a process flow in a first relay station according to further another embodiment of the present invention.

FIG. 14 is a view illustrating a data format of oPCR defined in the IEC61883.

FIG. 15 is a view illustrating one example of Common Isochronous Packet Format defined in the IEC61883.

FIG. 16 is a flowchart of a process flow when a first relay station receives a wireless stream after having obtained a wireless resource.

FIG. 17 is a block diagram illustrating a schematic structure of a wireless AV device in one embodiment in which a relay station secures a band autonomously.

FIG. 18 is a flowchart illustrating a process flow in a wireless AV device in one embodiment in which a relay station secures a band autonomously.

FIG. 19 is a block diagram illustrating a system structure for connecting between an IEEE1394 wired network and a wireless network which is realized by a wireless LAN.

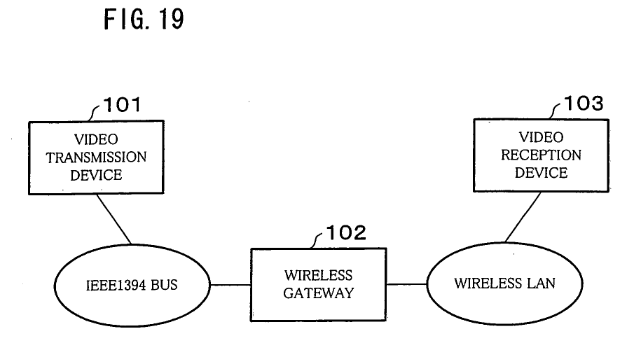

### BEST MODE FOR CARRYING OUT THE INVENTION

### First Embodiment

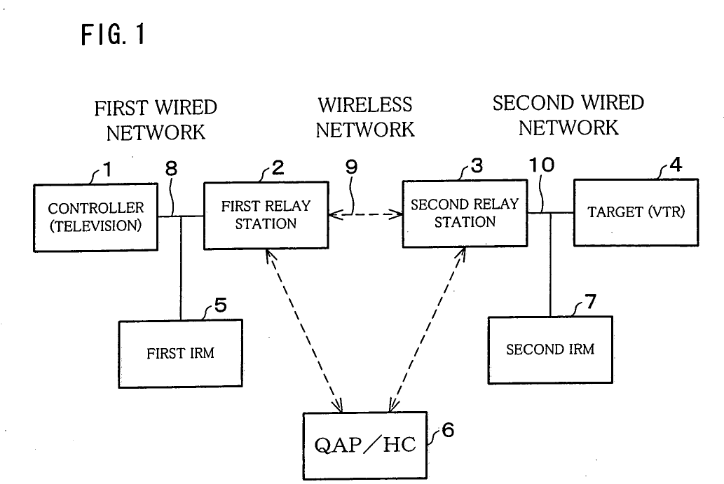

One embodiment of the present invention is described below with reference to FIGS. 1 through 5, and FIGS. 14 and 15.

(1-1. Network Structure)

FIG. 1 is a block diagram illustrating a schematic structure of a communications network system according to the present embodiment. As illustrated in FIG. 1, this communications network system includes a controller 1, a first relay station (network relay device) 2, a second relay station (network relay device) 3, a target 4, a first IRM (Isochronous Resource Manager) 5, a second IRM 7, and a QAP/HC 6.

The controller 1, the first relay station 2, and the first IRM 5 are connected to one another via a first wired network 8, which provides a first wired network system. Further, the second relay station 3, the target 4, and the second IRM 7 are connected to one another via a second wired network 10, which provides a second wired network system. In the present embodiment, the first and second wired network systems are assumed to be network systems compliant with IEEE1394.

Here, a simple explanation of IEEE1394 will be described. IEEE1394 is a high-speed serial interface standard which currently provides the following three transfer rates: 100 Mbps, 200 Mbps, and 400 Mbps. IEEE1394 has an isochronous transfer scheme where data that requires to be transferred at a given timing, such as voice and moving image, is transferred preferentially, and IEEE1394 has characteristics as interface for multimedia data.

Still further, the first relay station 2, the second relay station 3, and the QAP/HC 6 are connected to one another via the wireless network 9, which provides a wireless network system. In the present embodiment, this wireless network system is a network system compliant with IEEE P802.11e Drafted 5.0.

The controller 1 is a device on a system, i.e. a device used for control of the target 4 in this case when the user uses the foregoing communications network system. The present embodiment assumes that the controller 1 is a television set as video display means. In this case, with input means such as a remote controller for television set, the user provides operation control instructions to the devices.

The target 4 is a device whose operation is controlled by the controller 1. The present embodiment assumes that the target 4 is a VTR (Video Tape Recorder) as video signal output means. That is, the present embodiment assumes a system operation where the video signal outputted from the VTR is transmitted to a television set as the controller 1 via the second wired network 10, the wireless network 9, and the first wired network 8.

The first relay station 2 is a device for relaying signals between the first wired network system and the wireless network system, and is connected to the first wired network 8 and the wireless network 9. The second relay station 3 is a device for relaying signals between the wireless network system and the second wired network system, and is connected to the wireless network 9 and the second wired network 10.

The first IRM 5 is a device which performs management of signal transmission bands and channels in the first wired network system. The second IRM 7 is a device which performs management of signal transmission bands and channels in the second wired network system. The QAP/HC 6 is a device which manages a transmission right in the wireless network system.

(1-2. Message Sequence for Securing of a Band)

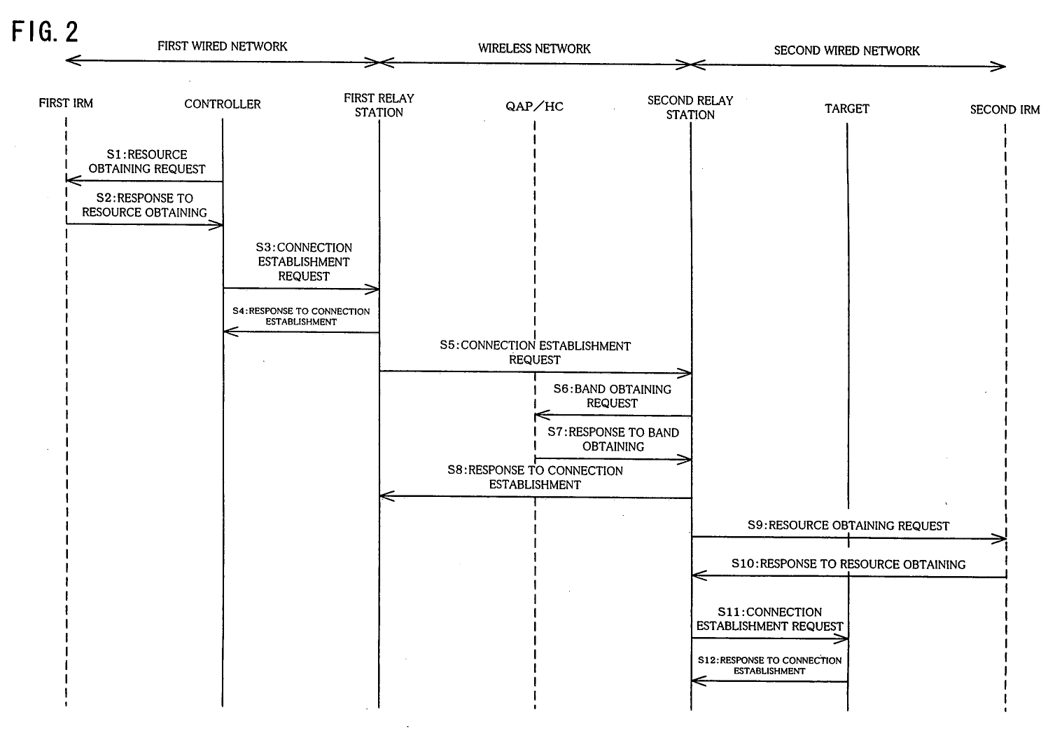

Next, the following will describe a message sequence for securing of a band in the foregoing communications network system with reference to FIG. 2. First, in Step 1 (hereinafter referred to as “S1”), upon determination of the target 4 to be controlled by a user's operation or the like, the controller 1 transmits a request for obtaining of a band and a channel on the first wired network system where the controller 1 is connected. The first IRM 5 secures a requested band and channel and then transmits a resource obtaining response to the controller 1 (S2). When succeeding in obtaining the band and channel, the controller 1 transmits a connection establishment request to the first relay station 2 (S3). The first relay station 2 determines whether the designated connection is available for establishment, and then transmits a connection establishment response to the controller 1 (S4).

The first relay station 2, upon receipt of the connection establishment request from the controller 1, confirms that the first relay station 2 receives a stream over the wireless network 9 and that the first relay station 2 and the second relay station 3 are not a QAP/HC. Thereafter, the first relay station 2 transmits, to the second relay station 3, a request for establishment of connection between the first relay station 2 and the second relay station 3 (S5). The second relay station 3, upon receipt of the connection establishment request from the first relay station 2, transmits a band obtaining request to the QAP/HC 6 (S6).

The QAP/HC 6 allocates a band requested from the second relay station 3 and then transmits a band obtaining response to the second relay station 3 (S7). The second relay station 3 having received the band obtaining response determines whether establishment of connection with the first relay station 2 is possible in view of factors including the band obtaining result, and then transmits, to the first relay station 2, a connection establishment response including the determination result (S8).

Next, the second relay station 3 transmits, to the second IRM 7, an obtaining request for obtaining of a band and channel on the second wired network system where the second relay station 3 is connected (S9). The second IRM 7 secures a requested band and channel, and then transmits a resource obtaining response to the second relay station 3 (S11). When succeeding in obtaining the band and channel, the second relay station 3 transmits a connection establishment request to the target 4 (S11). The target 4 determines whether establishment of the designated connection is possible, and then transmits a connection establishment response to the second relay station 3 (S12).

Note that, the present embodiment assumes that the controller 1 can identify the target 4 before start of a band securing process, and a communications path from the controller 1 to the target 4 can be determined in advance in accordance with the identification result. As a method for realizing this arrangement, one of various methods, for example, will be described as follows:

First, the first relay station 2 transmits, to the second relay station 3, a request for obtaining of information on devices connected to the second wired network 10 where the second relay station 3 is connected, and obtains this information. Thereafter, the controller 1 accesses the first relay station 2 to obtain the information on devices connected to the second wired network system, and then selects a device to be connected from among these devices, i.e. the target 4. The first relay station 2 obtains information on the target 4 selected by the controller 1, more specifically information of Config ROM and PCR (Plug Control Register), from the target 4 via the second relay station 3 to create a virtual target 4 in accordance with the obtained information. From that time forward, communications are carried out in such a manner that the controller 1 accesses the virtual target 4 provided in the first relay station 2.

(1-3. Structure of Relay Stations)

Next, the following will describe structures of the first relay station 2 and the second relay station 3. Note that, the first relay station 2 and the second relay station 3 have substantially the same structure, and both of them are simply referred to as “relay station 21” in the following description. The following description, which is given based on the first relay station 2, is also basically applied to the second relay station 3 in the same manner.

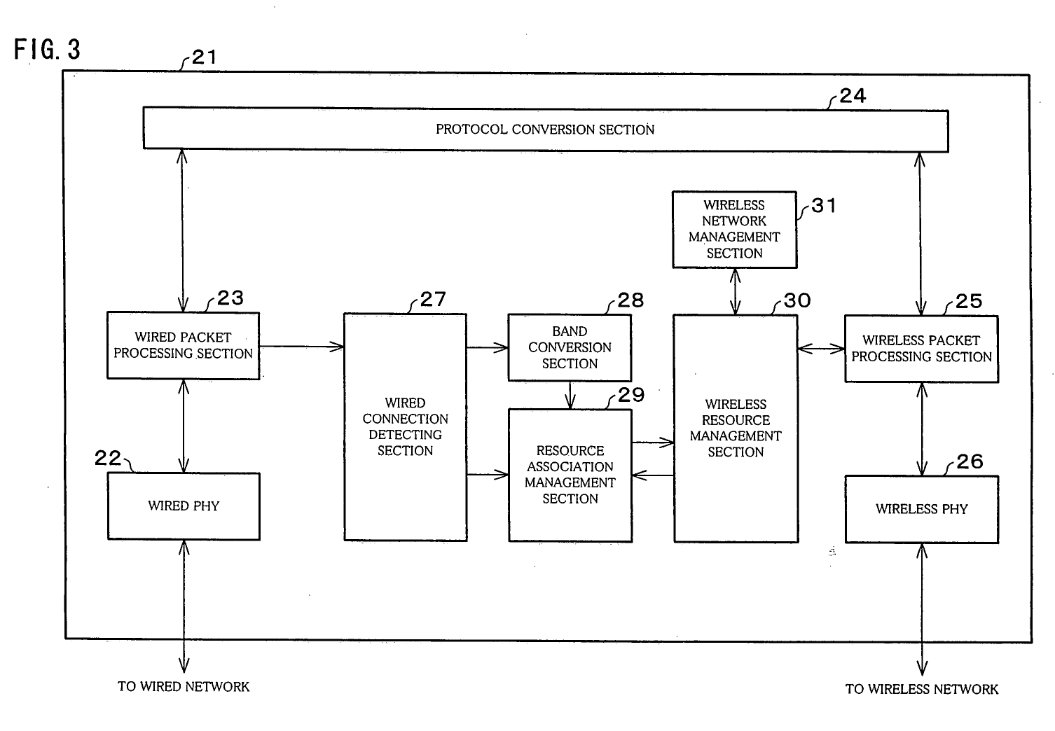

FIG. 3 is a block diagram illustrating a schematic structure of the relay station 21. As illustrated in FIG. 3, the relay station 21 includes a wired PHY 22, a wired packet processing section 23, a protocol conversion section 24, a wireless packet processing section 25, a wireless PHY 26, a wired connection detecting section (event/state detecting section; data detecting section) 27, a band conversion section (communication resource determination section) 28, a resource association management section 29, wireless resource management section (communications resource management section) 30, and a wireless network management section (network management section) 31.

The wired PHY 22, which is connected to the first wired network 8, is a physical layer responsible for receiving and transmitting packets and control signals via this wired network. The wired packet processing section 23 identify a packet received by the wired PHY 22 and performs processing according to the type of the received packet, or the wired packet processing section 23 creates a packet in response to a request from an application (not shown) and the protocol conversion section 24 and then passes the created packet to the wired PHY 22. The protocol conversion section 24 converts a packet having been received via the wired network, i.e. IEEE1394 packet in the present embodiment into a packet format in the wireless network, or the protocol conversion section 24 converts a packet having been received via the wireless network into a packet format in the wired network packet, i.e. IEEE1394 packet.

The wireless PHY 26, which is connected to the wireless network 9, is a physical layer responsible for receiving and transmitting packets and control signals via this wireless network. The wireless packet processing section 25 identify a packet received by the wireless PHY 26 and performs processing according to the type of the received packet, or the wireless packet processing section 25 creates a packet in response to a request from an application (not shown) and the protocol conversion section 24 and then passes the created packet to the wireless PHY 26.

The wired connection detecting section 27, upon receipt of a packet indicating connection establishment, addition, or cutoff by the wired packet processing section 23, detects the connection establishment, addition, or cutoff. The band conversion section 28 calculates a bandwidth required for wireless communications on the basis of bandwidth information obtained in the communications over the wired network.

The resource association management section 29 associates a connection on the wired network with a wireless resource (bandwidth, TSID, and others) obtained corresponding to the connection. The wireless resource management section 30 manages a wireless resource obtained by the relay station 21. The wireless network management section 31 stores information on which station on the wireless network is a QAP/HC performing band management.

(1-4. Process Flow in Relay Station)

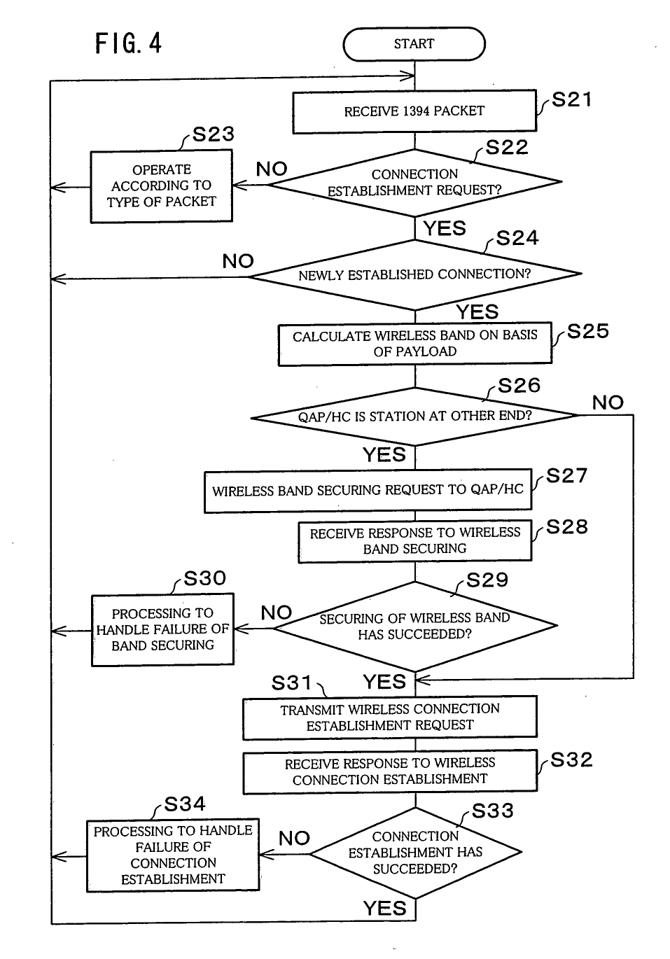

Next, the following will describe a process flow in the first relay station 2 with reference to a flowchart of FIG. 4. In S21, the wired PHY 22 waits for receipt of an IEEE1394 packet, and upon receipt of the IEEE1394 packet, passes the received IEEE1394 packet to the wired packet processing section 23.

The wired packet processing section 23, upon receipt of the IEEE1394 packet from the wired PHY 22, analyzes a content of the IEEE1394 packet and determines whether the IEEE1394 packet concerned is one for connection establishment request (S22). If “NO” in S22, i.e. if the received packet is not a packet for connection establishment request, the wired packet processing section 23 performs an operation according to the content of the received packet (S23), and then returns to a packet receipt wait state in S21. On the other hand, if “YES” in S22, i.e. if the received packet is a packet for connection establishment request, the received packet is transmitted to the wired connection detecting section 27.

The wired connection detecting section 27 checks, from data contained in the packet indicating a connection establishment request, on which plug (oPCR) the connection concerned is made to, so as to determine whether the connection is one that is newly established or one that overlays an already established connection (S24). If “NO” in S24, i.e. if it is determined as being a request for establishment of the already established connection, the resource association management section 29 does nothing and returns to the packet receipt wait state in S21. This is because a band for wireless streams has been already secured.

On the other hand, if “YES” in S24, i.e. if the connection is a newly established connection, a payload value included in the foregoing packet is passed to the band conversion section 28. Note that, “payload” refers to a maximum size of data contained in ISO packet in the IEEE1394 standard. The band conversion section 28 calculates a bandwidth required for wireless transmission on the basis of this payload value (S25). A method of calculating this wireless bandwidth will be described later.

The wired connection detecting section 27 passes, to the resource association management section 29, information on which plug (oPCR) the connection having been requested for establishment is made to. The resource association management section 29 determines, in accordance with (i) the plug to which the connection has been established and (ii) previously determined path information, which wireless station communications are to be made with, and then passes to the wireless resource management section 30 an MAC address of a wireless station that is a destination as well as the bandwidth information obtained earlier.

The wireless resource management section 30 obtains an MAC address of the QAP/HC 6 from the wireless network management section 31, and determines whether the obtained MAC address is an address of a relay station that is a station at the other end on the wireless network (i.e. the second relay station 3 if the relay station 21 is the first relay station 2), or an address of the other station (S26). Details of this determination method will be described later in Section 6 under the title of “Autonomous Securing of a Band by Relay Station”.

In the present embodiment, the QAP/HC 6 is neither the first relay station 2 nor the second relay station 3, so that it is determined in S26 as “NO”. From this, it is apparent that a transmitting station (second relay station 3) of a wireless stream can obtain the wireless resource.

Also, the wireless resource management section 30 manages TSID (ID for identifying a stream in an MAC layer) used between the first relay station 2 and the station at the other end. A station that obtains a wireless band newly assigns a TSID to a wireless stream which requests allocation of a band. In the present embodiment, the wireless resource management section 30 notifies the resource association management section 29 of information indicating that a station which will obtain a wireless resource is the second relay station 3 and that neither a stream transmitting station nor stream receiving station are the QAP/HC 6, i.e. information indicating that direction is a direct link (Explanation of the “direction” will be described later). Further, the wireless resource management section 30 prepares a request for wireless connection establishment to transmit the request to a wireless stream transmitting station (second relay station 3) through the wireless packet processing section 25 and the wireless PHY 26 (S31).

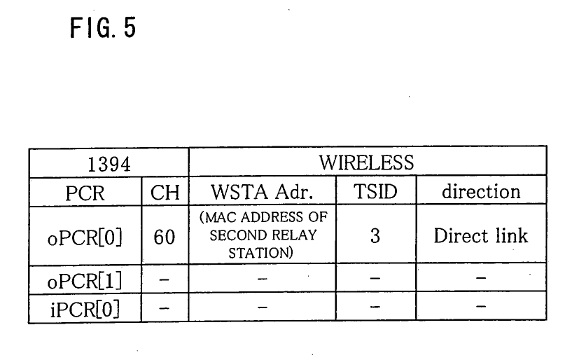

Now, how the resource association management section 29 manages association of an IEEE1394 stream with a wireless stream is explained with reference to a Table of FIG. 5. As illustrated in FIG. 5, the resource association management section 29 manages, as information on IEEE1394 stream, (i) a PCR and (ii) a channel (CH) indicating a destination of a stream stored in the PCR, and also manages, as information on wireless stream, (a) a MAC address of a station which has registered a TSPEC, (b) a TSID of the TSPEC concerned, and (c) a direction. The TSPEC is a group of parameters to be specified for obtaining of a wireless band by the QAP/HC 6 and includes the TSID and the direction. The TSID is an identifier for identifying a wireless stream. A combination of the MAC address and the direction, shown in this Table, allows a wireless stream to be uniquely identified. The direction indicates which of the following directions the wireless stream is transmitted: (i) an uplink (a direction where the stream is flown from a station that is not the QAP/HC 6 to the QAP/HC 6), (ii) a downlink (a direction where the stream is flown from the QAP/HC 6 to a station that is not the QAP/HC 6), and (iii) a direct link (a direction where the stream is flown from a station that is not the QAP/HC 6 to another station that is not the QAP/HC 6).

The Table in FIG. 5, as an example, indicates a stream outputted from the first relay station 2 to the wired network 8 through a 60-channel from oPCR[0], MAC address=MAC address of the second relay station 3, TSID=3, direction=direct link, and association with a stream supplied from the wireless network 9.

Back to the flowchart of FIG. 4, in S26, if it is determined that the QAP/HC 6 is a station at the other end (second relay station 3), the wireless resource management section 30 assigns a TSID to the wireless stream concerned, and thereafter prepares a wireless band securing request to transmit the request to the station at the other end through the wireless packet processing section 25 and the wireless PHY 26 (S27). Upon receipt of a response to securing of a wireless band through the wireless PHY 26 and the wireless packet processing section 25 (S28), the wireless resource management section 30 determines whether securing of a wireless band has succeeded (S29). If “YES” in S29, i.e. if the securing of a wireless band has succeeded, the wireless resource management section 30 prepares a wireless connection establishment request, as described earlier, to transmit the request to the station at the other end through the wireless packet processing section 25 and the wireless PHY 26 (S31). On the other hand, if “NO” in S29, i.e. if securing of a wireless band has been failed, the wireless resource management section 30 performs postprocessing to handle the failure of the securing of a band (S30), and then returns to the packet receipt wait state in S21.

The wireless resource management section 30, upon receipt of a response to wireless connection establishment through the wireless PHY 26 and the wireless packet processing section 25 (S32), determines whether that connection establishment has succeeded (S33). If “YES” in S33, i.e. if the connection establishment has succeeded, the wireless resource management section 30 transmits a TSID, included in this response, to the resource association management section 29, and enters the TSID value into an entry where the PCR, channel, MAC address, and direction have been already registered, and thereafter returns to the packet receipt wait state in S21. On the other hand, if “NO” in S33, i.e. if the connection establishment has been failed, the wireless resource management section 30 performs processing to handle the failure of wireless connection establishment (S34), and thereafter returns to the packet receipt wait state in S21.

Note that, in the process flow in the first relay station 2, the second relay station 3 basically converts a process on the wired network into a process on the wireless network, and vice versa. That is, the second relay station 3, upon receipt of the wireless connection establishment request from the first relay station 2, transmits a result as the response to wireless connection establishment to the first relay station 2. The second relay station 3 having detected connection establishment on the wireless section performs, to the target 4, an operation for resource securing and connection establishment in the normal IEEE 1394.

(1-5. Method of Calculating a Wireless Bandwidth)

Next, the following will describe the method of calculating the wireless bandwidth on the basis of the payload valued defined in the IEEE1394 standard. According to the IEC61883 that is a standard for digital interface for IEEE1394 electronic audio/video devices, the foregoing oPCR includes a maximum size of data stored in one IEEE1394 ISO packet, described in units of QUADLET. It is 1 QUADLET=4 bytes.

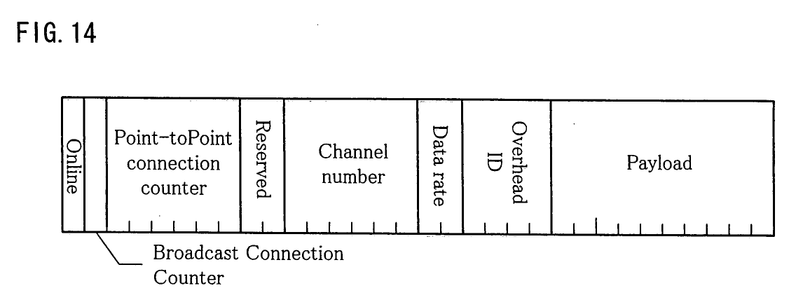

FIG. 14 is a view illustrating a data format of the oPCR defined in the IEC61883 standard. As illustrated in FIG. 14, the oPCR is composed of the following data regions: Online, Broadcast Connection Counter, Point-to-Point connection counter, Reserved, Channel number, Data rate, Overhead ID, and Payload. In FIG. 14, the oPCR is laterally calibrated in one bit increments, and the oPCR is 32-bit data, i.e. 4-byte data. The contents in the respective data regions are defined in the IEC61883 and explanation thereof are omitted here. Incidentally, the foregoing payload value is equivalent to a value indicated in the Payload of the oPCR.

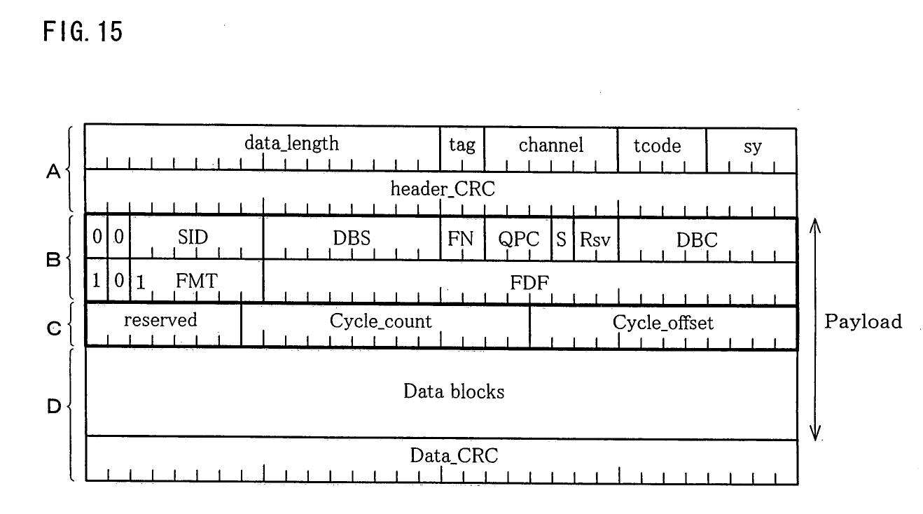

FIG. 15 illustrates one example of a Common Isochronous Packet Format defined in the IEC61883 standard, with a position in the IEEE1394 ISO packet. As illustrated in FIG. 15, this ISO packet is broadly divided into header region and data region of the ISO packet. As in FIG. 14, it is laterally calibrated in one bit increments in FIG. 15.

The header region of the ISO packet indicates header information of this entire ISO packet, and is composed of 4-byte header data region and 4-byte header-use CRC (Cyclic Redundancy Check) region. The data region of the ISO packet stores data carried by this ISO packet, and is composed of data field and 4-byte data-use CRC region. The foregoing data field is composed of a CIP header region, a SPH region, and a source packet region. The CIP header region and the SPH region are header regions defined in the IEC61883 standard, and detailed explanation thereof is omitted here. The source packet region is real data such as stream data, for example. The payload value indicates a size of the data field (=CIP header region, SPH region, and source packet region).

When a stream transmitted in the form of the ISO packet is MPEG2-TS, a data packet (group of packets) of the stream data is stored in the ISO packet in the following manner: a CIP header (2 QUADLET) is stored, and then n-number of one-eighth of {SPH (1 QUADLET)+MPEG2-TS packet (47 QUADLET)} are stored (where n is any positive integer, provided that a packet size is less than a maximum length of the ISO packet). A size of this part is expressed as payload, and a size of data (SPH+MPEG2-TS packet) transmitted in the form of one ISO packet is (payload−2)×4×8=32×(payload−2) (in bits).

In the IEEE1394 standard, ISO packets are transmitted 8000 times per second, so that a maximum value of the amount of data transmitted for one second is 32×(payload−2)×8000=256000×payload−2)(in bps)=0.256×(payload−2)(in Mbps). For example, when the Payload is 48 (=192 bytes; one MPEG2-TS packet, at the maximum, in one ISO packet is transmitted), a bandwidth required for transmission of a SPH+MPEG2-TS packet is 0.256×(48−2)=11.776 (Mbps).

Now, assume that a stream is transmitted in the form of SPH+MPEG2-TS by wireless. The IEEE1394 standard, which is a transmission scheme with extremely high reliability, eliminates the need for retransmission of a packet in stream transmission. However, wireless transmission, which is of a low reliability, is absolutely required to increase the reliability by retransmission of an unsuccessfully transmitted packet. On this account, to secure a bandwidth that is equivalent to about one-tenth of a stream body, 11.776×1.1=12.95≈13 (Mbps) is designated for a parameter, MeanDataRate (mean data rate), of the TSPEC.

(1-6. Process in Relay Station Upon Receipt of Stream)

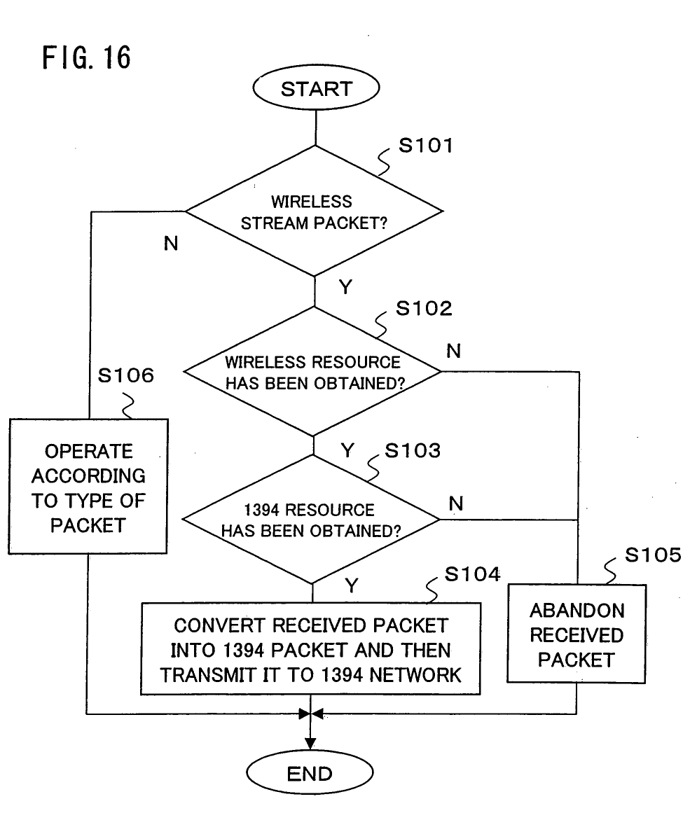

Next, the following will describe a process in the first relay station 2 upon receipt of a wireless stream after obtaining of a wireless resource with reference to a flowchart of FIG. 16. The wireless packet processing section 25, when having detected a receipt of a wireless packet through the wireless network 9, determines whether the received wireless packet is a wireless stream packet (S101). If it is determined that the received wireless packet is not a wireless stream packet (“NO” in S101), the wireless packet processing section 25 performs an operation according to the content of the received packet (S106).

On the other hand, if “YES” in S101, i.e. if it has been determined that the received wireless packet is a wireless stream packet, the wireless resource management section 30 determines whether a wireless resource has been obtained for the wireless stream (S102). Here, the wireless resource management section 30 determines that a resource has been obtained for the wireless stream when (i) resource (WSTA Adr. And TSID) information included in the wireless stream packet concerned and (ii) a direction found from a relationship between a transmitting station of the wireless stream packet concerned and a QAP/HC are described in the Table (see FIG. 5) illustrating association of an IEEE1394 stream, managed by the resource association management section 29, with a wireless stream. If the received wireless stream has not obtained a wireless resource (“NO” in S102), the wireless packet processing section 25 determines that the received packet is a packet transmitted improperly, and then abandons the received packet (S105).

On the other hand, if it is determined that the wireless stream concerned has obtained a wireless resource (“YES” in S102), the wired connection detecting section 27 similarly determines whether the wireless stream has obtained a 1394 resource (S103). This determination is performed in such a manner that the wired connection detecting section 27 inquires the resource association management section 29 about whether the Table of FIG. 5 includes description of a 1394 resource (channel number) corresponding to the wireless stream concerned. If “NO” in S103, i.e. if the received wireless stream packet has not obtained a 1394 resource, the wireless packet processing section 25 abandons the received packet (S105).

On the other hand, if it is determined that the wireless stream packet concerned has secured a 1394 resource (“YES” in S103), the wireless packet processing section 25 passes that packet to the protocol conversion section 24. The protocol conversion section 24 converts the received packet into a format for 1394 packet, and thereafter transmits it to first wired network 8 through the wired packet processing section 23 and the wired PHY 22 (S104).

Note that, in the above example, upon receipt of a wireless stream packet that has not obtained a 1394 resource or a wireless resource, the received wireless stream packet is abandoned. Alternatively, upon receipt of a wireless stream packet, a wireless resource and/or a 1394 resource, which has not been obtained yet, may be obtained so that the wireless stream packet can be transmitted to the wired network. Second Embodiment, which will be described later, takes as an example a case where a resource of a transfer destination is obtained after receipt of a stream packet.

Note that, the foregoing description explains a process for securing of a wireless band. Change of a band and release of a band may be realized in the same manner.

Further, in the present embodiment describes a process of detecting an operation for obtaining of a resource of an IEEE1394 network to secure a wireless band. However, an arrangement of a network is not limited to this arrangement. However, the present invention is applicable to a network through which data is transmitted after securing of a resource such as a band.

In S26 in the flowchart of FIG. 4, the first relay device 2 detects a receipt of a stream in a wireless section and determines which station the QAP/HC is, and thereafter it is determined whether the first relay device 2 or other station is to secure a wireless band. However, the present invention is applicable to this arrangement if adopted is a station which is connected to a network having a limitation of a station that can secure a communication resource, not limited to such a network relay device in the present embodiment, regardless of whether the station performs a relay to other network.

Further, in the present embodiment, a receipt of an IEEE1394 connection establishment request packet from the wired PHY 22 by the wired packet processing section 23 triggers a start of a process for obtaining of a wireless band. What triggers obtaining of a wireless band is not limited to this. Alternatively, it may be an instruction from the controller 1, other device, or a relay station (especially, transmission/reception start instruction), a notification from an application (not shown) on the present relay station, or detection of a receipt of a stream from other network as described in Second Embodiment.

Further, a timing of obtaining a wireless band, not limited to a moment right after obtaining of a wired band is detected, may be a moment after the instruction or notification from the application, as described above, is detected, i.e. a moment after a lapse of some time since obtaining of a wired band is detected.

### Second Embodiment

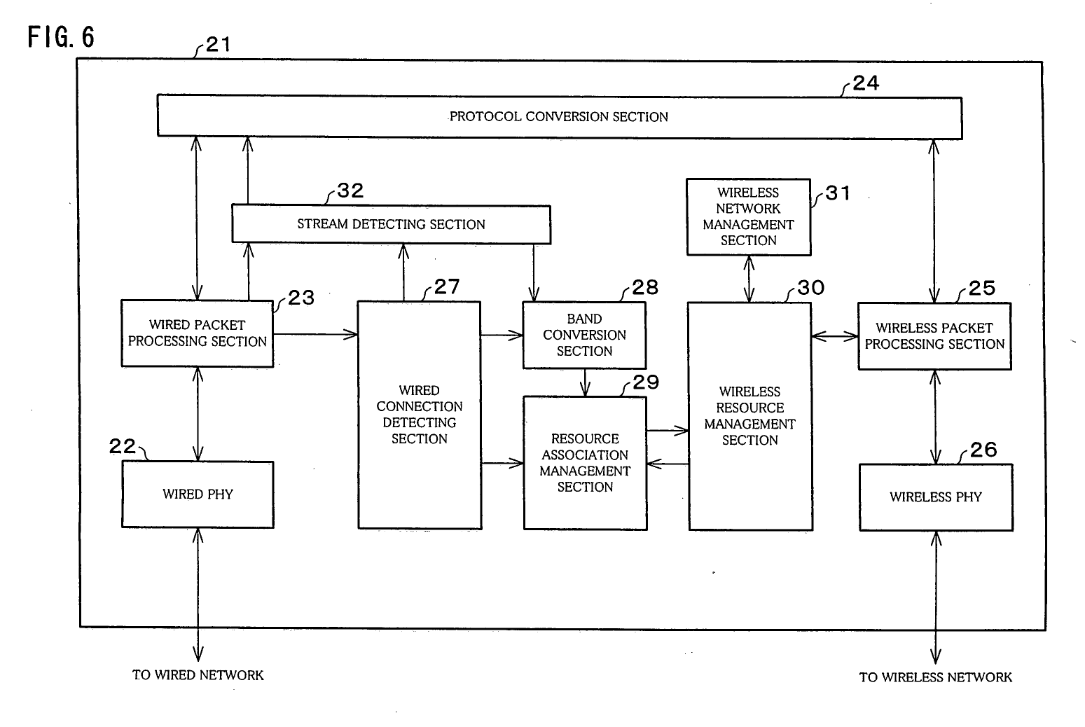

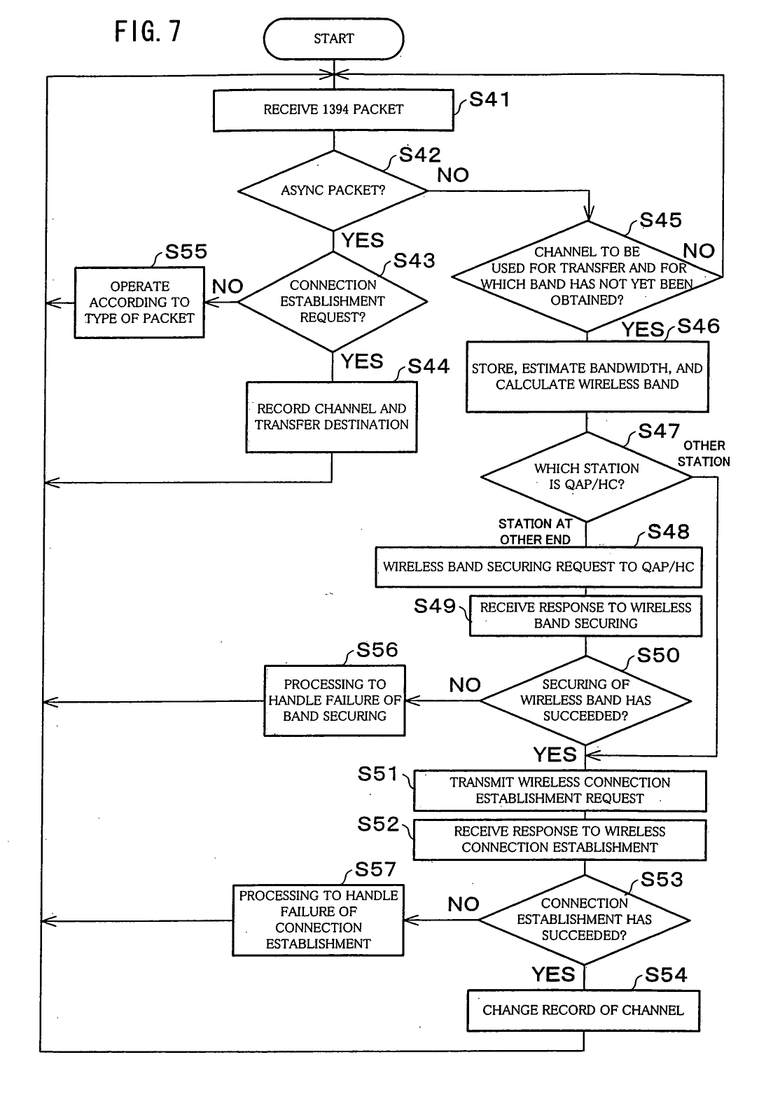

The following will describe one embodiment of the present invention with reference to FIGS. 6 and 7. Note that, members having the same functions as those described in the First Embodiment are given the same reference numerals and explanations thereof are omitted here.

In the First Embodiment, taken as an example is a case where the relay station detects an operation for obtaining or release of a band on one network, after which it obtains or releases a band on the other network. In the present embodiment, taken as an example is a case where the relay station detects a stream transmitted through one network, after which it obtains a band on the other network. Specifically, taken as an example is a case where the second relay station 3 receives a stream through the second wired network 10, after which it obtains a band on the wireless network 9.

(2-1. Structure of Relay Device)

FIG. 6 is a block diagram illustrating a schematic structure of the relay station 21 according to the present embodiment. The following description, which is given based on the second relay station 3, is also basically applied to the first relay station 2 in the same manner. As illustrated in FIG. 6, the relay station 21 according to the present embodiment is provided with a stream detecting section (communication resource determination section), in addition to the members illustrated in FIG. 4. The other members are the same as those in FIG. 4 and explanations thereof are omitted here.

The stream detecting section 32, when the wired packet detecting section 23 receives a stream packet, analyzes the received packet. If the received stream is addressed to a channel that is the same as a channel that has been obtained in advance from the wired connection detecting section 27, the wired packet detecting section 23 estimates a bandwidth required for transmission of the stream concerned from the total size of a packet received in a given period, and then provides the bandwidth information to the band conversion section 28.

(2-2. Process Flow in Relay Station)

Next, the following will describe a process flow in the second relay station 3 with reference to a flowchart of FIG. 7. In S41, the wired PHY 22 waits for receipt of an IEEE1394 packet. Upon receipt of the IEEE1394 packet, the wired PHY 22 passes it to the wired packet processing section 23.

The wired packet processing section 23 analyzes the received packet to determine whether the packet concerned is an ASYNC packet (S42). If “YES” in S42, i.e. if the packet concerned is the ASYNC packet, it is determined whether the packet concerned is one for a connection establishment request (S43).

If “YES” in S43, i.e. if the packet concerned is a packet for connection establishment request, the packet is transmitted to the wired connection detecting section 27. The wired connection detecting section 27 extracts channel information contained in the connection establishment request concerned and transfers the extracted channel information to the stream detecting section 32. The stream detecting section 32 records the channel concerned as a channel “to be used for transfer and for which a wireless resource has not yet been obtained” (S44).

The wired connection detecting section 27 passes, to the resource association management section 29, information on which plug (iPCR) the connection was made to. The resource association management section 29 determines, in accordance with (i) the plug to which the connection has been established and (ii) previously determined path information, which wireless station communications are to be made with, and then records the determination result in the Table of FIG. 5 (S44). Thereafter, the process returns to the packet receipt wait state in S41.

On the other hand, if “NO” in S43, i.e. if the received packet is not a packet for connection establishment request, the wired packet processing section 23 performs an operation according to the content of the received packet (S55), and then returns to the packet receipt wait state in S41.

If “NO” in S42, i.e. if the received packet is not an ASYNC packet, that is, an ISO Packet, the packet concerned is transmitted to the stream detecting section 32. The stream detecting section 32 checks on whether a channel to which the received ISO packet is addressed has been recorded as a channel “to be used for transfer and for which a wireless resource has not yet been obtained” (S45).

If “NO” in S45, i.e. if a channel to which this packet is addressed is not recorded as a channel to be used for transfer, nothing is done, and the process returns to the packet receipt wait state in S41. Further, if a channel to which this packet is addressed is a channel to be used for transfer and for which a wireless resource has been obtained (also “NO” in S45), the packet concerned is transferred to the protocol conversion section 24. The protocol conversion section 24 converts the received stream packet into a packet for wireless transmission, and then transmits the converted packet to the first relay station 2 through the wireless packet processing section 25 and the wireless PHY 26. Thereafter, the process returns to the packet receipt wait state in S41.

On the other hand, if “YES” in S45, i.e. if a channel to which this packet is addressed is a channel to be used for transfer and for which a wireless resource has not yet been obtained, the stream detecting section 32 stores the ISO packet which is addressed to the same channel for a predetermined period, and estimates a bandwidth of the stream itself from division of a total size of data portion by a storage time. Then, the stream detecting section 32 passes the estimated bandwidth to the band conversion section 28. The band conversion section 28 converts the estimated bandwidth into a wireless bandwidth (S46). The band conversion section 28 passes the wireless bandwidth to the resource association management section 29. The resource association management section 29 passes the bandwidth information and a destination MAC address to the wireless resource management section 30.

The following band obtaining process (from S47 to S53, S56, and S57) is the same as the process from S26 to S34 in FIG. 4, and explanation thereof is omitted here.

If “YES” in S53, i.e. if a wireless connection establishment has succeeded, the wireless resource management section 30 notifies a success of the wireless connection establishment to the stream detecting section 32. The stream detecting section 32, in response to the notification, changes the state of a channel of the stream concerned to “a channel to be used for transfer and for which a wireless resource has been obtained” (S54). This allows a subsequent stream which is transmitted to the same channel to be automatically transmitted to the wireless network through the aforementioned S45 and the following steps.

Note that, the present embodiment takes, as an example, a case where a receipt of a 1394 packet is detected, and then a wireless resource is obtained. As an alternative example, such an arrangement may be adopted that a receipt of a 1394 packet is monitored, and it is determined as the end of a packet transmission if no packet has been received for a predetermined period or more, and then a wireless resource is released. Further, in the foregoing description, estimation of a bandwidth upon receipt of an ISO packet “to be transferred and for which a wireless resource has not been obtained” is performed by division of a data size by a time after storage of the ISO packet for a predetermined period. However, the storage is not always necessary. After one data size is measured and recorded, the data concerned may be deleted. Moreover, a combination of networks is not limited to a combination of an IEEE1394 network and a wireless network. The present invention is applicable to any network where data is transmitted after at least one relay station has secured a resource such as a band.

### Third Embodiment

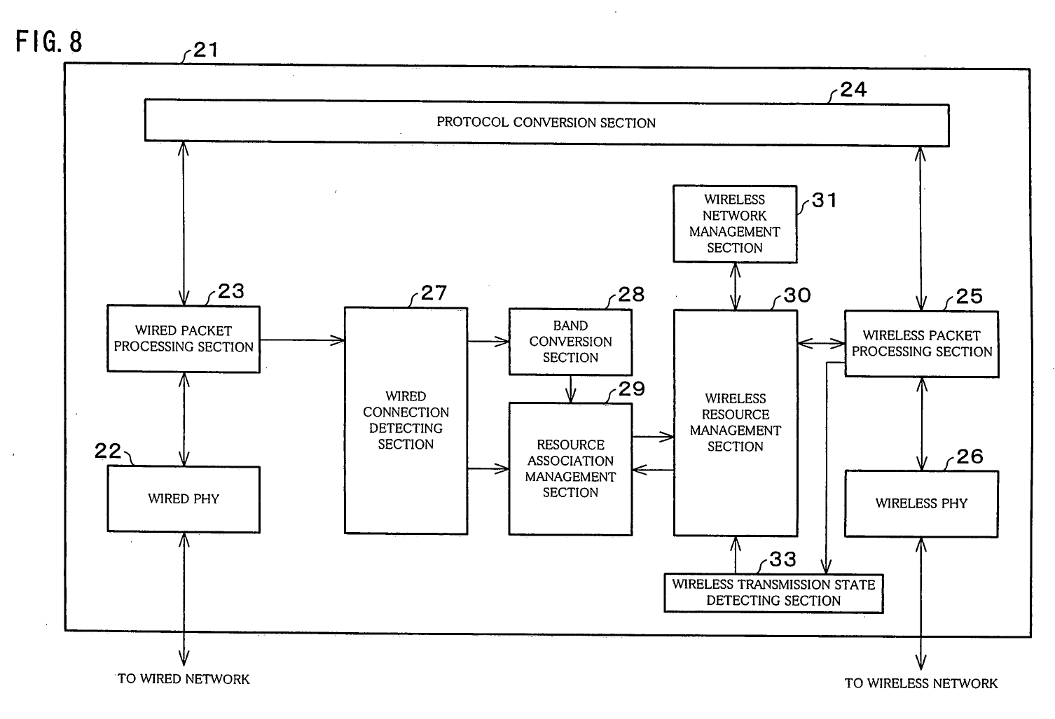

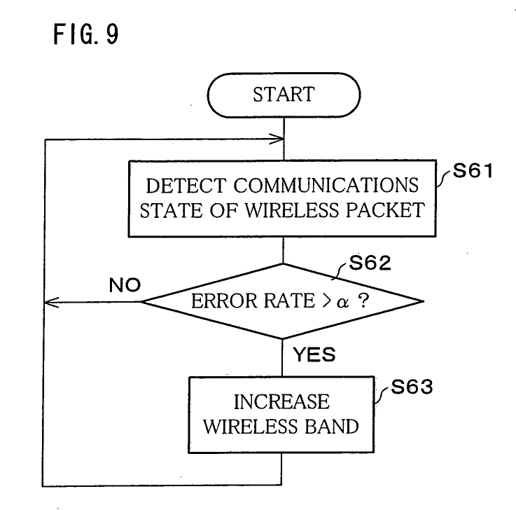

The following will describe one embodiment of the present invention with reference to FIGS. 8 and 9. Note that, members having the same functions as those described in the foregoing Embodiments are given the same reference numerals and explanations thereof are omitted here.

In the present embodiment, taken as an example is a case where while a relay station transfers a stream transmitted from one network to another network, only a band obtained on the network concerned is changed depending upon a transfer state of another network. Specifically, taken as an example is a case where while the second relay station 3 transfers a stream having been received from the second wired network 10 to the wireless network 9, a band to be obtained on the wireless network 9 is changed.

(3-1. Structure of Relay Device)

FIG. 8 is a block diagram illustrating a schematic structure of the relay station 21 according to the present embodiment. Note that, the following description, which is given based on the second relay station 3, is also basically applied to the first relay station 2 in the same manner. As illustrated in FIG. 8, the relay station 21 according to the present embodiment is provided with a wireless transmission state detecting section (communications state detecting section) 33, in addition to the members illustrated in FIG. 4. The other members are the same as those in FIG. 4 and explanations thereof are omitted here.

The wireless transmission state detecting section 33 judges on a reception state of a stream in transmission, from an ACK packet that the wireless packet processing section 25 receives. The wireless transmission state detecting section 33 requests the wireless resource management section 30 to increase a wireless band when the necessity arises.

(3-2. Process Flow in Relay Station)

Next, the following will describe a process flow in the second relay station 3 with reference to a flowchart of FIG. 9. The following description shows an operation of the second relay station 3 in transmission of a stream through the wireless network 9.

In response to a wireless stream packet transmitted from the second relay station 3 through the wired PHY 22, the wired packet processing section 23, the protocol conversion section 24, the wireless packet processing section 25, and the wireless PHY 26, the first relay station 2, which is a stream receiving station, returns an ACK according to a scheme defined in the IEEE P802.11e. In normal circumstances, a Group ACK is used for this ACK. The Group ACK is one for returning a reception state of plural sets of data having been transmitted before then in a collective manner.

The wireless packet processing section 25, upon receipt of the Group ACK through the wireless PHY 26, transmits to the wireless transmission state detecting section 33. The wireless transmission state detecting section 33 calculates packet transmission error rate on the basis of (i) the number of packets targeted for ACK and (ii) the number of packets having succeeded to be received (S61). As a result of a comparison between the resulting error rate and a predetermined value α (S62), if the error rate is larger than α (“YES” in S62), the wireless transmission state detecting section 33 requests the wireless resource management section 30 to increase a bandwidth. The wireless resource management section 30 increases a bandwidth in the same steps as those in the First Embodiment (S63).

Thereafter, the wireless packet processing section 25 increases the number of times a packet transmission of which has been failed is retransmitted, by using the increased bandwidth, so as to properly transmit the packet to a station at the other end. Especially, a scheme where a stream transmitting station can make a request for transmission of the ACK easily allows to increases the number of times a packet is retransmitted in a given period in such a manner that transmission of the ACK is requested in shorter intervals for retransmission of a packet having been received improperly on a priority basis.

The above description has taken, as an example, the case where the wireless packet processing section 25 detects an ACK and makes a judgment from an error rate, regardless of whether a packet is to be retransmitted, for increase of a wireless band. In an alternative example, “a rate of packet transmission having been actually made including retransmission” or other criterion of judgment may be adopted. Moreover, information other than the ACK may be used for the judgment so that a wireless bandwidth is increased or decreased according to a judgment result. For example, as a result of comparison by the wireless packet processing section 25 between (a) a transmission possible time included in a transmission right assignment packet (QoS CF-Poll) transmitted from the QAP/HC 6 and (b) a time taken for actual transmission, an already-obtained wireless bandwidth is decreased if such a circumstance continues where the time taken for actual transmission is less than the transmission possible time, whereas an already-obtained wireless bandwidth is increased if such a circumstance continues where the time taken for actual transmission is greater than the transmission possible time. Further, the above description takes, as an example, the case of using a reception rate of the data packet concerned as the state of communications on the network. Alternatively, the state of communications for other data packet and the content of a notification on the state of communications, transmitted from other station, may be used for judgment on the state of communications on the network.

Further, a combination of networks is not limited to a combination of an IEEE1394 network and a wireless network. The present invention is applicable to any network where data is transmitted after at least one relay station has secured a resource such as a band.

### Fourth Embodiment

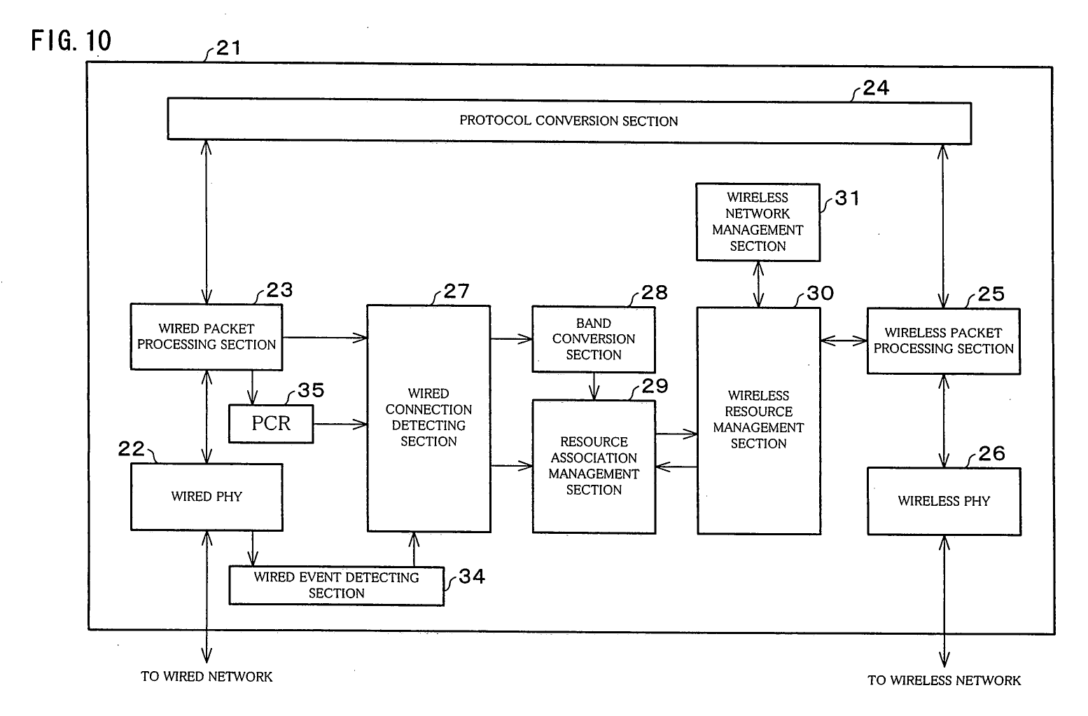

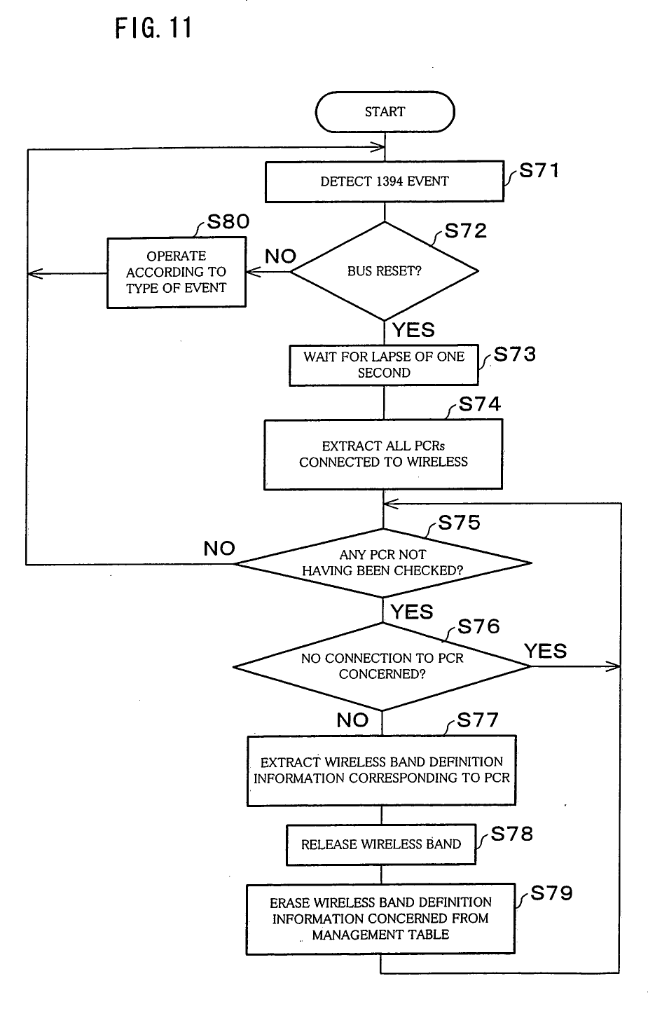

The following will describe one embodiment of the present invention with reference to FIGS. 10 and 11. Note that, members having the same functions as those described in the foregoing Embodiments are given the same reference numerals and explanations thereof are omitted here.

In the present embodiment, taken as a example is a case where if a setting for a stream on one network is cleared, a resource associated with the cleared setting for a stream on other network is released by a relay station. Specifically, taken as an example is a case where the second relay station 3 detects clearance of the stream setting on the second wired network 10 and releases an obtained band on the wireless network 9.

(4-1. Structure of Relay Device)

FIG. 10 is a block diagram illustrating a schematic structure of the relay station 21 according to the present embodiment. Note that, the following description, which is given based on the first relay station 2, is also basically applied to the second relay station 3 in the same manner. As illustrated in FIG. 10, the relay station 21 according to the present embodiment is provided with a wired event detecting section (event/state detecting section; network detecting section) 34 and a PCR 35, in addition to the members illustrated in FIG. 4, but is not provided with the band conversion section 28. The other members are the same as those in FIG. 4 and explanations thereof are omitted here.

The wired event detecting section 34 detects information transmitted in the form other than an IEEE1394 link layer packet, especially detects the occurrence of a bus reset, and then notifies the occurrence to the wired connection detecting section 27. The PCR 35, which is a Plug Control Register in the relay station 21 as a 1394 node, is rewritable by lock transaction from other IEEE1394 node.

(4-2. Process Flow in Relay Station)

Next, the following will describe a process flow in the first relay station 2 with reference to a flowchart of FIG. 11. The wired PHY 22 analyzes a signal having been received through the first wired network 8. If the received signal is not a link layer packet, the wired PHY 22 notifies as such to the wired event detecting section 34 (S71). The wired event detecting section 34 determines whether the notification is about a bus reset (S72). If it is not a bus reset (“NO” in S72), the wired event detecting section 34 performs an operation according to the content of that event (S80), and the process returns to S71.

If “YES” in S72, i.e. if the detected event is the occurrence of a bus reset, the wired event detecting section 34 notifies the occurrence of a bus reset to the wired connection detecting section 27. The wired connection detecting section 27, upon receipt of a notification about the occurrence of a bus reset, waits for a lapse of one second (S73). This is because the IEC61883 defines the rules that upon occurrence of a bus reset, information on connection, held by the PCR, is cleared and that an application having established a connection before a bus reset establishes the same connection within one second after the bus reset occurs.

After a lapse of one second, the wired connection detecting section 27 extracts all the PCRs associated with a wireless stream (S74) and performs the following check to all the PCRs (S75). First, the wired connection detecting section 27 checks a PCR to see whether a connection is established (S76). If a connection is established (“YES” in S76), the wired connection detecting section 27 determines that a stream transfer will continue. Then, without doing anything, the wired connection detecting section 27 checks a next PCR (returns from S75).

On the other hand, if a connection is not established (“NO” in S76), a wireless resource is released since a stream reception through the first wired network 8 is stopped. Specifically, a number of the PCR concerned is notified to the resource association management section 29. The resource association management section 29 extracts wireless stream information (MAC address, TSID, and direction) corresponding to the notified PCR (S77), and notifies the extracted information to the wireless resource management section 30. On the basis of this information, the wireless resource management section 30 issues a DELTS request to the wireless packet processing section 25 so that a wireless band is released through the wireless PHY 26 (S78). This release of the wireless band is, depending upon whether a HC is a stream transmitting station (second relay station 3), directly performed by the first relay station 2 or is instructed to the second relay station 3 to perform.

Further, the resource association management section 29 erases an entry corresponding to a released resource (S79) and then checks a next PCR (returns from S75). In S75, if it is determined that checks for all the PCRs have been completed (“NO” in S75), the process returns to S71.

In the above description, the occurrence of a bus reset is adopted as a trigger for a start of judgment on clearance of a setting for an IEEE1394 stream. However, the present invention is not limited to this. For example, the occurrence of lock transaction to the PCR or other event may be adopted. If the occurrence of lock transaction to the PCR is the trigger, the occurrence of lock transaction is detected by the wired packet processing section 23, not by the wired event detecting section 34. In this case, it is sufficient that the PCR to be checked is a PCR to which the lock transaction is performed.

Further, in the present embodiment, a trigger (bus reset) is detected for judgment on clearance of a setting for an IEEE1394 stream, a timing at which a setting for a stream is detected is not limited to this. Alternatively, the wired connection detecting section 27 may check the state of the PCR 35 at regular or irregular intervals so as to detect a clearance of a setting for a stream.

Further, in the above description, in order to determine the presence or absence of a setting for a stream, the PCR and a value of a connection counter included in the PCR is used. This is however not the only possibility. As an alternative example, it may be arranged such that as a result of checking on the presence of a node on the IEEE1394 after a bus reset, if the controller 1, which is a stream reception node, is cleared after the bus reset, it is determined that transmission of a stream is not necessary. As another alternative example, it may be arranged such that the relay station 21 makes access to the resource manager (IRM) on the IEEE1394 to detect a release of a channel or a bandwidth used for a stream, for determination of a stream clearance. The foregoing PCR may be a PCR of a station at the other end targeted for connection, not a PCR of the first relay station 2.

Further, in the present embodiment, a resource for a wireless stream is released as a result of detection of clearance of the setting for a stream on the IEEE1394. This is however not the only possibility. Alternatively, a resource on the IEEE1394 may be released as a result of detection of clearance of a wireless station (second relay station 3 in the present embodiment) that transmits and receives a wireless stream or a stream. This detection may be carried out at any intervals or regular intervals, or may be carried out when some event, e.g. flowing of no packet in a wireless section for a given period has been detected.

Further, a combination of networks is not limited to a combination of an IEEE1394 network and a wireless network. The present invention is applicable to any network where data is transmitted after at least one relay station has secured a resource such as a band.

### Fifth Embodiment

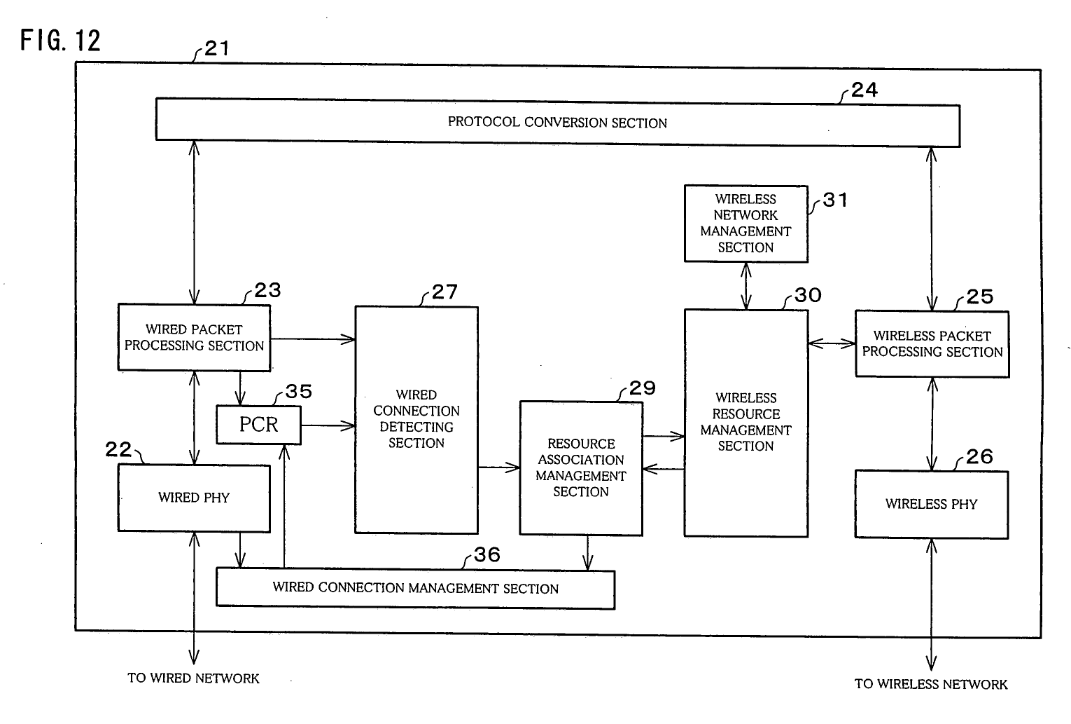

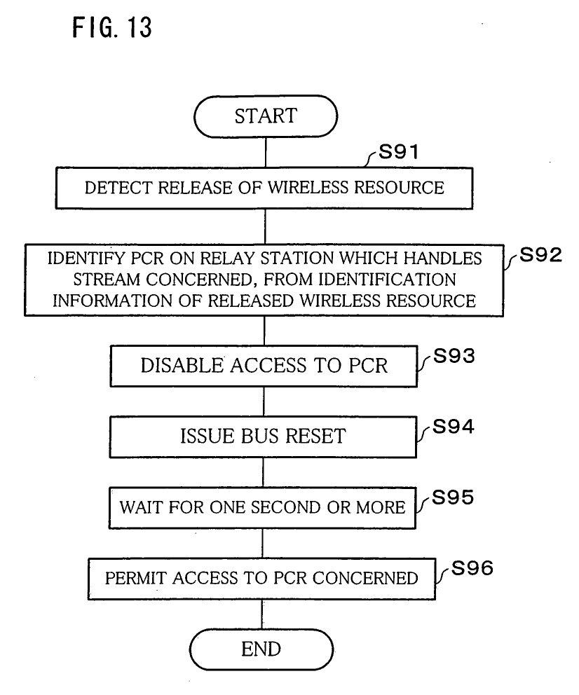

The following will describe one embodiment of the present invention with reference to FIGS. 12 and 13. Note that, members having the same functions as those described in the foregoing Embodiments are given the same reference numerals and explanations thereof are omitted here.

In the present embodiment, taken as an example is a case where when a relay station has detected a release of a resource on other network, corresponding to a resource on one network, or the relay station has failed to obtain a resource on other network, it releases the resource on one network. Specifically, as an example taken is a case where when the first relay station 2 has failed to obtain a resource on the wireless network 9 or detected a release of a resource on the wireless network 9, it releases an obtained band on the first wired network 8.

(5-1. Structure of Relay Device)

FIG. 12 is a block diagram illustrating a schematic structure of the relay station 21 according to the present embodiment. Note that, the following description, which is given based on the first relay station 2, is also basically applied to the second relay station 3 in the same manner. As illustrated in FIG. 12, the relay station 21 according to the present embodiment is provided with a wired connection management section (connection management section) 36, instead of the wired event detecting section 34, in the structure illustrated in FIG. 10. The other members are the same as those in FIG. 10 and explanations thereof are omitted here.

The wired connection management section 36 identifies a connection on the wired network that corresponds to a wireless resource obtaining of which has been failed or which is released, noticed from the wireless resource management section 30, and then performs an operation for cut-off of the identified connection.

(5-2. Process Flow in Relay Station)

Next, the following will describe a process flow in the first relay station 2 with reference to a flowchart of FIG. 13. The wireless resource management section 30 receives a wireless resource release notification or a wireless resource obtaining failure notification through the wireless PHY 26, the wireless packet processing section 25 (S91). This notification may be one from a station at the other end targeted for wireless connection or from the QAP/HC 6.

The wireless resource management section 30 notifies information on that released resource to the resource association management section 29. The resource association management section 29 extracts a PCR associated with the notified information and then notifies the extracted PCR to the wired connection management section 36 (S92). Note that, a connection established in the notified PCR assumes to be a connection established by the controller 1.

It is ideal that the wired connection management section 36 could perform a process for cut-off of a notified connection by itself. However, the wired connection management section 36 cannot perform cut-off of a connection in a normal process for cut-off of a connection since the IEC61883 defines the rule that an established connection (Point-to-Point connection) can be cut off by only an application which has established the connection concerned. In view of this, the wired connection management section 36 disables a notified lock transaction from other 1394 node with respect to the PCR 35 (S93), and then instructs the wired PHY 22 to issue a bus reset (S94).

If this connection to the PCR has been established by other 1394 node, the node concerned (controller 1 in the present embodiment) detects the occurrence of a bus reset and tries to restore a connection. However, the PCR 35 does not respond to a lock transaction by other IEEE1394 node, so that the node concerned cannot restore a connection. Therefore, it is expected that the controller 1 retries to recover a connection for one second after the occurrence of the bus reset and then gives up the connection recovery. As a result, a connection is cut off.

The first relay station 2 waits for a lapse of one second or more after the occurrence of the bus reset (S95), and permits access to the PCR 35 (S96), to which a lock transaction has been disabled. This allows other station to establish a new connection.

The above arrangement adopts a method of not responding to lock transaction to the PCR 35 so that other IEEE1394 node is unable to recover a connection. Alternatively, an IEEE1394 node having the PCR itself may be a repeater node that accepts no transactions. If the first relay station 2 has any other IEEE1394 node, an operation of the IEEE1394 node itself having the PCR concerned may be stopped so that a bus reset is issued from other node on the first relay station 2. If the first relay station 2 is a resource manager (IRM) on the first wired network, access to CHANNELS_AVAILABLE or BANDWIDTH_AVAILABLE register of the IRM may be blocked. These methods are not the only possibility. Any other method may be adopted if the method makes it possible to prevent a connection establishment by other IEEE1394 node (PCR rewriting by lock transaction).

Further, in the present embodiment, a bus reset is caused after access to the PCR 35 is disabled. This is however not the only possible timing for disabling the access. Alternatively, the timing may be a moment right after the occurrence of a bus reset. It is essential only that the access be disabled at the time when other node carries out a connection recovery.

In the above description, an example of how the relay station operates between the IEEE1394 network and the wireless network has been given. This connection cut-off scheme is available for not only a relay station connecting a plurality of networks, but also a node connected to only the IEEE1394. The present invention is applicable to any communications scheme provided it limits a node capable of cutting off a connection, regardless of whether the network is IEEE1394 network.

As described above, a network relay device according to the present invention is arranged so as to be connected to a first communications network and a second communications network, being of a property which is different from that of the first communications network, with which said device can transmit data after securing a communications resource, said device including a first network interface where said device is connected to the first communications network and a second network interface where said device is connected to the second communications network, said device comprising: a data detecting section for detecting an operation regarding data communications in the first communications network via the first network interface; a communications resource calculation section for calculating a communications resource to be obtained, changed, or released in the second communications network, in accordance with the operation, regarding the data communications in the first communications network, detected by the data detecting section; and a communications resource management section for obtaining, changing, or releasing a communications resource in the second communications network via the second network interface on the basis of the communications resource calculated by the communications resource calculation section.

In the above arrangement, the data detecting section first detects an operation regarding data communications in the first communications network. In accordance with this operation, the communications resource calculation section calculates a communications resource to be obtained, changed, or released in the second communications network. On the basis of the calculated communications resource, the communications resource management section obtains, changes, or releases a communications resource in the second communications network.

That is, for example, for data transmission from a data transmitting station on the first communications network to a data receiving station on the second communications network, the data transmitting station first transmits, to the network relay device, a signal indicating that the data transmitting station is going to transmit data. This signal may be a signal normally used in the first communications network, so that it is not necessary for the data transmitting station to perform a special operation.

Then, on the network relay device, the data detecting section detects this signal from the data transmitting station as the operation regarding data communications. On the basis of a calculation result obtained by the communications resource calculation section, the communications resource management section obtains a communications resource in the second communications network. In this manner, communications with the data receiving station becomes possible. Here again, it is not necessary for the data receiving station to perform a special operation.

As described above, according to the above arrangement, for communications between communications stations respectively provided in communications network of mutually different types, it is not necessary for both of the communications stations to perform a special operation. Therefore, it is possible to use conventional devices as they are. This allows the user to easily introduce a wider communications network including communications networks of mutually different types.

### 6. AUTONOMOUS SECURING OF A BAND BY RELAY STATION

As described earlier, the relay station (first relay station 2 or second relay station 3) in the embodiments of the present invention can autonomously secure a wireless band (resource) by detecting an event/state of a communications network, such as MAC address of the QAP/HC 6 (see S26).

Therefore, according to the present invention, each relay station can appropriately obtain a communications resource even when the communications networks are of complicated structures or even when there are many relay stations connected so that each of the relay stations cannot determine, from only information on itself, whether it has a role of obtaining a resource for stream transmission or reception.

That is, there occurs no delay in establishment of a communications path due to a collision between a resource obtaining processing or other processing by the data transmitting station and a resource obtaining processing or other processing by the data receiving station, or due to a resource obtaining processing or other processing performed by neither the data transmitting station nor the data receiving station.

In the following sections, such autonomous securing of a wireless band will be described in detail.

(6-1. Embodiment of Autonomous Securing of a Band)

The following will describe one embodiment of autonomous securing of a band by a relay station (first relay station 2 or second relay station 3) with reference to FIGS. 1, 17, and 18.

(6-1-1. Structure)

In the foregoing communications network system (see FIG. 1), the wireless network 9 connecting among first relay station 2, the second relay station 3, and the QAP/HC 6 is a wireless network in conformity with IEEE P802.11e DraftD5.0.

First described is a structure of the first relay station 2 or the second relay station 3, which performs autonomous securing of a band. Note that, in the present section, the first relay station 2 and the second relay station 3 have substantially the same structure, and both of them are simply referred to as “wireless AV device 40” in the following description. That is, the following description, which is given based on the wireless AV device 40 as the first relay station 2, is also basically applied to the second relay station 3 in the same manner.

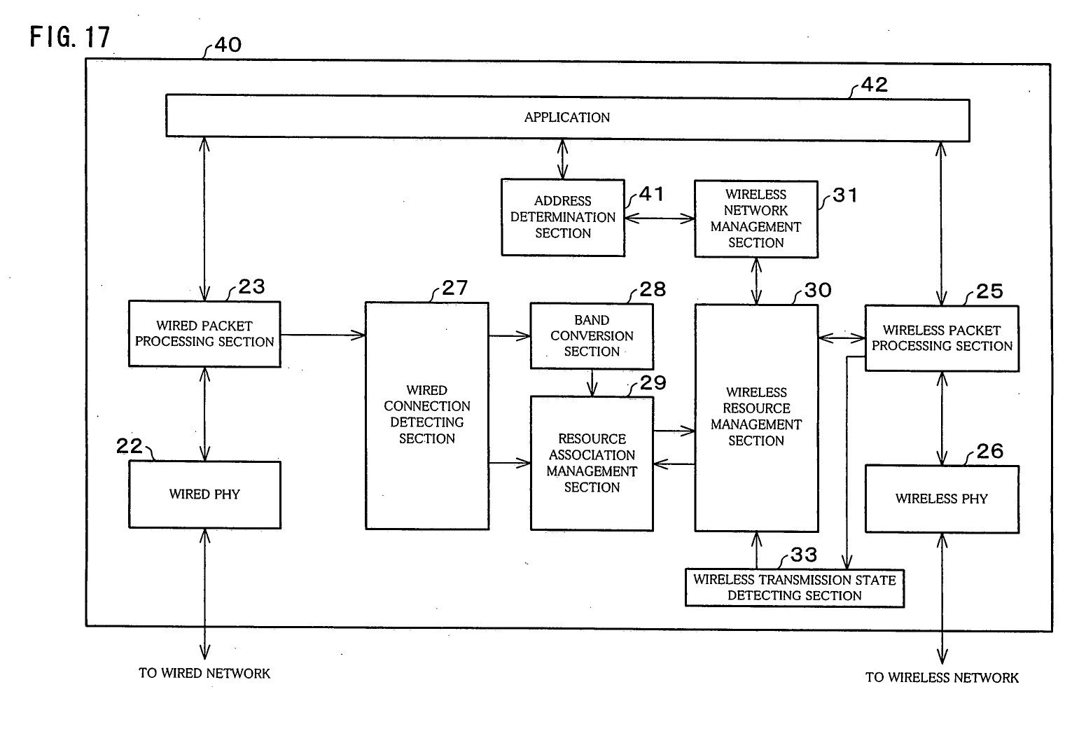

FIG. 17 is a block diagram illustrating a schematic structure of the wireless AV device 40. Note that, members having the same functions as those described in the above descriptions are given the same reference numerals and explanations thereof are omitted here.

The application 42 has a function of instructing determination of a station at the other end of communications, request for reservation of a communications band, start of stream transmission/reception, and others; and a function of presenting information to the user; and a function of accepting entry from the user, in addition to a function of the protocol conversion section 24, i.e. a function of converting a packet having been received through the wired network into a packet format in the wireless network or converting a packet having been received through the wireless network into a packet format in the wired network, i.e. a packet format in the IEEE1394.

An address determination section 41 compares between an MAC address of a station at the other end of communications, obtained from the application 42, and an MAC address of a QAP/HC, obtained from the wireless network management section 31, so as to determine whether they are identical with each other.

(6-1-2. Structure of Relay Station)

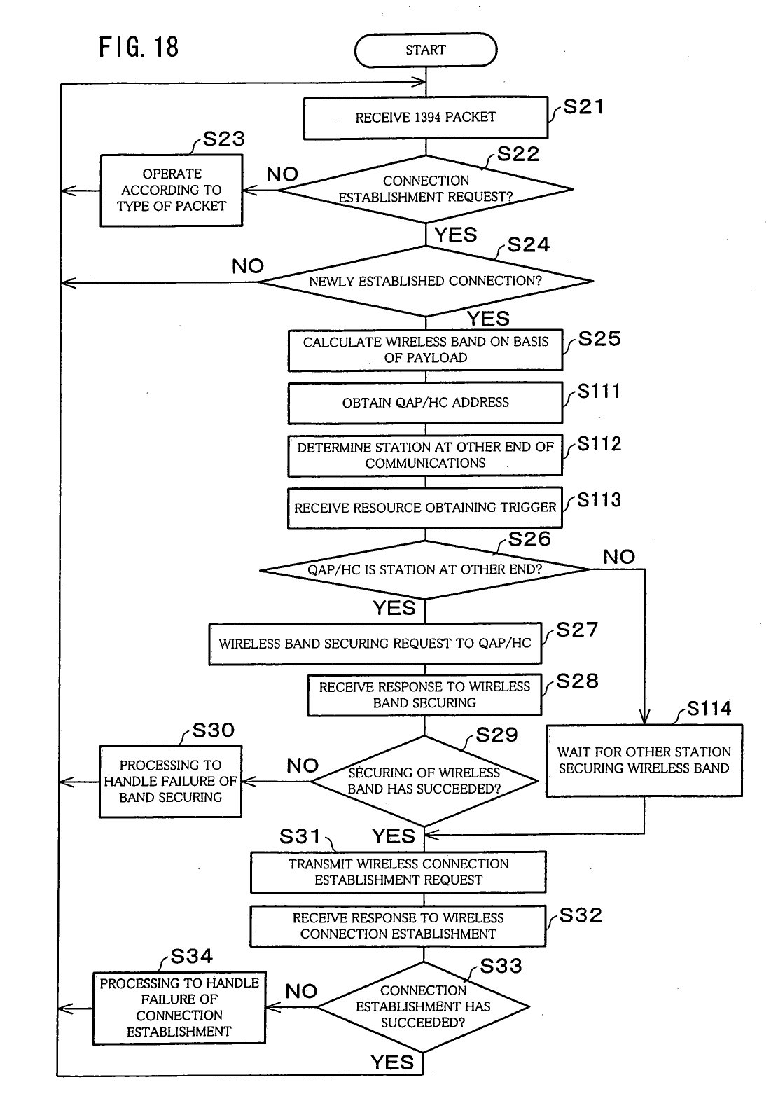

Next, the following will describe a process flow in the wireless AV device 40 with reference to a flowchart of FIG. 18. The following description assumes that the wireless AV device 40 is the first relay station 2 and gives a case when the wireless AV device 40, like a television, performs only stream reception.

Note that, in the flowchart of FIG. 18, the same steps as those in the foregoing flowchart of FIG. 4 are given the same reference numerals and explanations thereof are omitted here.

If “YES” in S24, i.e. if the connection is a newly established connection, a payload value included in the foregoing packet is passed to the band conversion section 28. Note that, “payload” refers to a maximum size of data contained in ISO packet in the IEEE1394 standard. The band conversion section 28 calculates a bandwidth required for wireless transmission on the basis of this payload value (S25).

The wired connection detecting section 27 passes, to the resource association management section 29, information on which plug (oPCR) the connection having been requested for establishment is made to.

The wireless resource management section 30 obtains an MAC address of the QAP/HC 6 to which the wireless AV device 40 belongs from the wireless network management section 31 (S111). Specifically, the wireless resource management section 30 detects an MAC address used when the first relay station 2 associates with the QAP/HC 6 and causes the wireless network management section 31 to store the detected MAC address. Note that, the MAC address of the QAP/HC 6, a target for association, is contained in a beacon which the QAP/HC 6 broadcasts.

Next, the application 42 determines a station at the other end of communications that is a stream transmitting station (S112). Specifically, this determination is performed as follows. The application 42 obtains device information on other wireless AV device connected to the wireless network 9, through the wireless PHY 26 and the wireless packet processing section 25. Thereafter, the application 42 presents, to the user, the obtained device information on other wireless AV device. In response to this, the user selects other wireless AV device, which is a station at the other end of communications, through the function of the application 42. Note that, when the user has determined station at the other end of communications, the application 42 stores the previously obtained bandwidth information and an MAC address of the station concerned at the other end of communications.

Upon determination of a station at the other end of communications, the application 42 communicates with an application on the station at the other end of communications, determines a stream to be communicated, and obtains attribute of this stream (bandwidth and others required for stream communications). Thereafter, the application 42 waits for a receipt of a trigger for obtaining of a wireless resource (resource obtaining trigger). Examples of an event which is the resource obtaining trigger include a user's push on a “start of communications” button with respect to the application 42.

The application 42, upon receipt of the resource obtaining trigger (S113), compares between the MAC address of the QAP/HC 6, stored in the wireless network management section 31, and the MAC address of the station at the other end of communications, stored in the application 42, through the function of the address determination section 41, so as to determine whether a relay station to be a station at the other end in the wireless network is the QAP/HC 6 (S26).

As a result of the comparison in S26, if the MAC address of the QAP/HC 6, stored in the wireless network management section 31, and the MAC address of the station at the other end of communications, stored in the application 42, are identical with each other, it is recognized that a station at the other end of communications is the QAP/HC 6. Therefore, the application 42 creates a wireless band securing request, through the function of the wireless resource management section 30, after having assigned a TSID to the wireless stream concerned. Then, the application 42 transmits this request to the QAP/HC 6, a station at the other end, through the wireless packet processing section 25 and the wireless PHY 26 so that the wireless AV device 40 obtains a wireless resource (S27).

(6-1-3. Supplementary Explanation)

In the above descriptions, in a network structure where a relay takes place between the wired network and the wireless network, the wireless AV device 40 detects reception of a stream through a wireless section, determines what station the QAP/HC 6 is, and thereafter determines whether the wireless AV device 40 or other station will secure a wireless band. However, any network structure may be adopted, and a relay station connected to such a network that limits a station which can secure a communications resource, can perform autonomous securing of a band, regardless of whether it relays to other network.

The above descriptions may be altered as follows.

Instead of the wireless network 9 in conformity with the IEEE P802.11e, other wireless network from which a communications resource is secured or a wired network may be used.

The above description has given the wireless AV device 40 as the first relay station 2 and an example of the first relay station 2. Instead of the wireless AV device 40, a telephone or other type of device may be used provided that it has an equivalent arrangement for communications.

In the above description, the wireless AV device 40 is used as the stream receiving station. However, the present invention is applicable to a case where with the same arrangement, the wireless AV device 40 is used as a stream transmitting station.

The MAC address of a reception beacon is not the only possible object from which a QAP/HC is distinguished from a non-QAP/HC. Alternatively, an address in a higher layer (e.g. address in a network layer) or others may be used. For example, according to whether an address in the network layer is a specific value, the QAP/HC may be distinguished from the non-QAP/HC.

The description of S112 has been given based on that a station at the other end of communications is determined in accordance with selection by the user. This is not however the only possible method for determining a station at the other end of communications. Alternatively, the application 42 may automatically select/determine in accordance with information on station at the other end of communications, held in advance by the application 42.

In the previous description, the application 42 communicates with an application on the station at the other end of communications, determines a stream to be communicated, and obtains attribute of this stream (bandwidth and others required for stream communications). This is however not the only possibility. As an example, it may be arranged such that the application 42 holds in advance various kinds of information such as a station at the other end, a stream to be communicated, and a stream attribute, so as to determine a stream to be communicated according to this information held by the application 42 and notify a stream attribute of the stream to be communicated to the wireless resource management section 30.

In the description of S113, given is a case where there explicitly exists a user's resource obtaining trigger (user's push of a “start of transmission” button with respect to the application 42). However, the resource obtaining trigger may be obtained from something other than the user. For example, when the wireless AV device 40 is a tuner capable of outputting a stream all the time, the application 42 may use, as the resource obtaining trigger, information obtained from the inside of the wireless AV device 40, an instruction from the controller 1, other device, or a relay station (especially, transmission/reception start instruction), detection of a receipt of a stream from other network, or others. For example, a receipt of an IEEE1394 connection establishment request packet from the wired PHY 22 by the wired packet processing section 23 may be simply used as the resource obtaining trigger.

In the description of S27, the application 42 creates a command to a station at the other end, corresponding to a trigger, to transmit this command to the station at the other end and wait. However, instead of just waiting, the application 42 may explicitly issue, to the station at the other end of communications, another command to make a request for securing of a wireless resource, which is not the command corresponding to the trigger, so as to cause the station at the other end of communications to secure a wireless resource. Similarly, the application 42 may issue a command to make a request for securing of a wireless resource to a third station which satisfies a limitation of network in a lower layer, so as to cause the third station to secure a resource.

Further, the wireless AV device 40 may make a request for obtaining, changing, or releasing a resource to other station (a station at the other end of transmission and reception or third station) when the wireless AV device 40 cannot obtain a resource. In this case, which communications station is requested for obtaining, changing, or releasing a resource among other stations depends upon a specification of a lower layer (e.g. IEEE P802.11e specification). According to this arrangement, the upper layer can issue a resource obtaining request without considering a limitation of a lower layer. Moreover, a transmitting station (or reception station) can always issue the resource obtaining request, thus allowing for a simple structure of the application 42.

(10) The previous descriptions has given a process for obtaining of a wireless band. Change of a band and release of a band are also realized in the same manner.

(11) The previous description has given a case where when the QAP/HC 6 manages a resource, the QAP/HC 6 obtains a resource. The wireless AV device 40 may obtain, change, or release a resource that the wireless AV device 40 manages. For example, the wireless resource management section 30 manages a TSID (ID for identifying a stream in the IEEE P802.11e-compliant MAC layer) used between the wireless AV device 40 and a station at the other end, so that a station which obtains a wireless band assigns a new TSID to a wireless stream which requires a band allocation. That is, what determines a value of the TSID is the wireless AV device 40 (first relay station 2 or second relay station 3) that is a station which makes a request for a wireless resource to the QAP/HC 6. Therefore, the present embodiment may adopt an arrangement where a relay station to determine the TSID is selected and decided, from among the wireless AV devices 40 (first relay station 2 or second relay station 3) connected to the wireless network 9.

(12) In the previous description, judgment on which station is a communications resource management station (QAP/HC 6), is made for determination of whether the wireless AV device 40 or other station secures a wireless band. This is however not the only possibility. Alternatively, the determination may be based on whether a station at the other end of communications exists in a unit which manages the same communications resource as that managed by the wireless AV device 40, in accordance with a specification of a lower layer, or whether the wireless AV device 40 transmits a stream. Further, the determination may be based on a communications path with a party at the other end of communications.

### 7. CONCLUSION

As described above, a network relay device according to the present invention may be arranged such that the operation regarding data communications in the first communications network, detected by the data detecting section, is obtaining, change, or release of a communications resource in the first communications network, for data transmitted from the first communications network to the second communications network.

According to the above arrangement, when the data detecting section detects obtaining, change, or release of a communications resource in the first communications network, obtaining, change, or release of a communications resource in the second communications network is carried out. This realizes to obtain, change, or release communications resources in the first communications network and the second communications network in relation to each other.

Further, a network relay device according to the present invention, in the above arrangement, may be arranged such that an operation, regarding data communications in the first communications network, detected by the data detecting section is reception or completed reception of data itself to be transferred from the first communications network to the second communications network.

According to the above arrangement, when the data detecting section detects reception or completed reception of data itself to be transferred from the first communications network to the second communications network, a resource in the second communications network is obtained, changed, or released. This allows for securing of a resource in the second communications network only when data flows to the second communications network, thus realizing an efficient use of a resource in the second communications network. Upon receipt of data transferred from the first communications network to the second communications network, it is possible to properly determine the amount of resource actually used for data communications, in view of size and reception time of the received data. Thus, it is possible to properly set a communications resource to be obtained, changed, or released in the second communications network.

Still further, a network relay device according to the present invention, in the above arrangement, may be arranged such that the communications resource calculation section calculates a communications resource in the second communications network, on the basis of a communications resource obtained, changed, or released in the first communications network.

According to the above arrangement, a communications resource to be secured in the second communications network is calculated on the basis of a communications resource obtained, changed or released in the first communications network. In view of obtaining, change, or release of a communications resource in the first communications network, it is possible to properly determine the amount of resource required for data communications. Thus, it is possible to properly set a communications resource to be secured in the second communications network.

Yet further, a network relay device according to the present invention, in the above arrangement, may be arranged such that the communications resource calculation section estimates a bandwidth of data transmitted through the communications resource obtained, changed, or released in the first communications network, and then calculates the communications resource in the second communications network on the basis of the estimated bandwidth.

According to the above arrangement, on the basis of information on a communications resource obtained, changed, or released in the first communications network, a bandwidth of data transmitted is estimated. Here, it is possible to perform a relatively accurate estimation of a bandwidth for data from information on communications resource. Then, a communications resource in the second communications network is calculated by using the bandwidth of this data, so that is it possible to more properly set a communications resource to be secured in the second communications network.

Further, a network relay device according to the present invention, in the above arrangement, may be arranged such that the communications resource calculation section calculates the communications resource to be secured in the second communications network, with consideration of a property of the second communications network.

According to the above arrangement, the communications resource to be secured in the second communications network is calculated with consideration of a property of the second communications network. Therefore, it is possible to properly secure a communications resource even when the reliability of communications varies in the second communications network, for example.

Still further, a network relay device according to the present invention, in the above arrangement, may be arranged such that the communications resource calculation section calculates a communications resource to be secured in the second communications network, on the basis of (i) a communications resource required for normal data transmission in the second communications network and (ii) a communications resource required for data retransmission.

According to the above arrangement, the communications resource to be secured in the second communications network is calculated on the basis of (i) a communications resource required for normal data transmission and (ii) a communications resource required for data retransmission. That is, by giving a consideration to a communications resource required for data retransmission, securing of a communications resource is performed with proper consideration of communications environment in the second communications network. Thus, it is possible to realize a stable communications.

Yet further, a network relay device of the present invention, in the above arrangement, may be arranged so as to further include a communications state detecting section for detecting a communications state in the second communications network, wherein: the communications resource management section changes the communications resource secured in the second communications network, in accordance with a change in communications state in the second communications network.

According to the above arrangement, a communications state in the second communications network is detected by the communications state detecting section, and a communications resource to be secured in the second communications network is changed in accordance with this detection result. This makes it possible to properly change a communications resource in accordance with variation in communications state in the second communications network. Thus, it is possible to realize more stable communications.

Further, a network relay device according to the present invention, in the above arrangement, may be arranged such that the communications state detecting section detects an error rate of data transmission in the second communications network, and if the error rate exceed a given value, the communications resource management section increases a communications resource to be obtained in the second communications network.

According to the above arrangement, a communications resource to be obtained in the second communications network is changed in accordance with the error rate of data transmission in the second communications network. Knowing the error rate can properly grasp the extent to which data retransmission should be made, so that it is possible to more properly change the communications resource to be obtained in the second communications network. Thus, it is possible to realize more stable communications.

Still further, a network relay device according to the present invention, in the above arrangement, may be arranged such that the communications state detecting section detects a data communications time in the second communications network, and as a result of comparison between the data communications time and a time given by an already allocated communications resource, the communications resource management section changes the communications resource obtained in the second communications network.

According to the above arrangement, by comparing between a communications time for data transferred to the second communications network and a time given by an already allocated communications resource, the communications resource to be obtained in the second communications network is changed. That is, for example, if a communications time for data transferred to the second communications network is less than the time given by an already allocated communications resource, such a control of reducing a communications resource to be obtained in the second communications network becomes possible. This makes it possible to prevent such a state of securing the communications resource in vain. Thus, it is possible to realize the efficient use of a band.

Yet further, a network relay device according to the present invention, in the above arrangement, may be arranged so as to further include a network management section for detecting a communications resource management station which manages a communications resource in the second communications network, wherein: by which communications station on the second communications network serves as the communications resource management station, detected by the network management section, the communications resource management section judges whether said network relay device is to obtain, change, or release a communications resource or is to request other communications station on the second communications network to obtain, change, or release a communications resource.

According to the above arrangement, the network management section detects a communications resource management station which manages a communications resource in the second communications network, and on the basis of which communications station this communications resource management station is, determined is a way of obtaining, changing, or releasing a communications resource in the second communications network. This makes it possible to properly obtain, change, or release a communications resource in the second communications network of any network structure.

Further, a network relay device according to the present invention is a network relay device, connected to (i) a first communications network with which said device can transmit data after securing a communications resource and (ii) a second communications network having a property which is different from that of the first communications network and with which said device can transmit data after securing a communications resource, said device including a first network interface where said device is connected to the first communications network and a second network interface where said device is connected to the second communications network, said device including: a network detecting section for detecting a network state in the first communications network through the first network interface; and a communications resource management section for releasing, if a communications resource in the first communications network is released, a communications resource in the second communications network, corresponding to the communications resource in the first communications network.

According to the above arrangement, the network detecting section first detects a network state in the communications network. Then, when a communications resource in the first communications network is released, the communications resource management section releases a communications resource in the second communications network, corresponding to the communications resource in the first communications resource. This makes it possible to reliably release, even when communications in the first communications network is unexpectedly cut off, the corresponding communications resource in the second communications network. Thus, it is possible to avoid a state of securing a band in vain.

Still further, a network relay device according to the present invention, in the above arrangement, may be arranged such that the network detecting section checks a network state in the first communications network at regular intervals.

According to the above arrangement, a network state in the first communications network is checked at regular intervals, so that it is possible to detect an unexpected cut-off of communications in the first communications network within a given period of time.

Yet further, a network relay device according to the present invention, in the above arrangement, may be arranged such that the network detecting section checks a network state in the first communications network upon receipt of notification of a predetermined event from the first communications network.

According to the above arrangement, upon receipt of notification of a predetermined event from the first communications network, a network state in the first communications network is checked. Here, for example, in a case where a band in the first communications network is released when communications in the first communications network is unexpectedly cut off, this case is detected as an event, and a communications resource in the second communications network can be released at a timing substantially the same as the timing when communications in the first communications network have been cut off.

Further, a network relay device according to the present invention, in the above arrangement, may be arranged such that the network detecting section detects, as a network state in the first communications network, presence or absence of other entity which communicates data with said device in the first communications network.

According to the above arrangement, upon detection of absence of a station at the other end of data communications with the network relay station in the first communications network, a communications resource in the second communications network is released. Therefore, it is possible to reliably detect cut-off of communications in the first communications network and release a communications resource in the second communications network.

Still further, a network relay device according to the present invention, in the above arrangement, may be arranged such that the network detecting section detects, as a network state in the first communications network, a resource obtaining state in the first communications network.

According to the above arrangement, by detection of the resource obtaining state in the first communications network, it is determined whether a communications resource in the second communications network should be released. Therefore, if communications in the first communications network are cut off, processing in the first communications network releases a resource for the communications in the first communications network. Thus, by detection of release of this resource, it is possible to release the corresponding communications resource in the second communications network.

Yet further, a network relay device according to the present invention, in the above arrangement, may be arranged such that the network detecting section detects, as a network state in the first communications network, a connection established state in the first communications network.

According to the above arrangement, by detection of a connection established state in the first communications network, it is determined whether a communications resource in the second communications network should be released. Therefore, if communications in the first communications network have been cut off, processing in the first communications network cuts off the communications concerned. Thus, by detecting cut-off of this connection, it is possible to release the corresponding communications resource in the second communications network.

Further, a network relay device according to the present invention is a network relay device, connected to (i) a first communications network with which said device can transmit data after securing a communications resource and (ii) a second communications network having a property which is different from that of the first communications network, said device including a first network interface where said device is connected to the first communications network and a second network interface where said device is connected to the second communications network, said device comprising: a network component to which other communications station connected to the first communications network makes access so as to secure a communications resource on the first communications network; and a connection management section for controlling availability/unavailability of the network component.

According to the above arrangement, the connection management section controls availability/unavailability of the network component to which other communications station connected to the first communications network makes access so as to secure a communications resource on the first communications network. Here, on the network relay device side, the network component is set as being unavailable when a communications resource in the first communications network should be released. In this case, a communications station in communications through the first communications network gives up a connection recovery when the network component has become unavailable, since there exists no party at the other end. Therefore, the communications resource is released.

That is, according to the above arrangement, in the first communications network, even if it is defied such that only a communications station which has established a connection can cut off the connection concerned, the network relay devise can cut off this connection substantially. Therefore, for example, even when connection has been cut off on the second communications network, a connection on the first communications network is cut off, so that it is possible to release a communications resource.

Still further, a network relay device according to the present invention may be such that the connection management section notifies change in availability/unavailability of the network component to said other communication station.

According to the above arrangement, the connection management section, after having made the network component unavailable, notifies unavailability of the network component to other communications station connected to the first network, thereby causing a quick execution and failure of a connection recovery on the first network and realizing release of a communications resource.

Yet further, a network relay device according to the present invention, in the above arrangement, may be arranged such that the first communications network is in conformity with IEEE 1394.

According to the above arrangement, the first communications network is in conformity with IEEE1394 having an isochronous transfer scheme where data that must be transferred at certain timings, such as voice and moving image, is transferred on a priority basis. This realizes an optimum communications of multimedia data and the like.

Further, a network relay device according to the present invention, in the above arrangement, may be arranged such that the second communications network is a wireless network.

According to the above arrangement, the second communications network is a wireless network. This realizes to establish such a system that a plurality of wired networks at distance from one another are connected through a wireless network.

Still further, a network relay device according to the present invention, in the above arrangement, may be arranged such that the first communications network is in conformity with IEEE1394, and an event notified from the first communications network is a bus reset defined by the IEEE 1394.

According to the above arrangement, upon receipt of notification of the bus reset defined in the IEEE1394, a network state in the first communications network is checked. Therefore, by detecting the bus reset as an event, it is possible to release a communications resource in the second communications network at a timing substantially the same as a moment when communications on the first communications network is cut off.

Yet further, a network relay device according to the present invention, in the above arrangement, may be arranged such that the first communications network is in conformity with IEEE1394, and as a resource obtaining state in the first communications network, used is a value of BANDWIDTH_AVAILABLE or CHANNELS_AVAILABLE register held by an Isochronous Resource Manager in the first communications network.

As described above, by using a value of BANDWIDTH_AVAILABLE or CHANNELS_AVAILABLE register held by the Isochronous Resource Manager, it is possible to reliably detect the resource obtaining state.

Further, a network relay device according to the present invention, in the above arrangement, may be arranged such that the first communications network is in conformity with IEEE1394, and as the connection established state in the first communications network, used is a connection counter value of a Plug Control Register held by a data transmitting station or data receiving station in the first communications network.

As described above, by using a connection counter value of a Plug Control Register held by a data transmitting station or data receiving station in the first communications network, it is possible to reliably detect the connection established state.

Still further, a network relay device according to the present invention, in the above arrangement, may be arranged such that the network component is any one of a register, a Plug Control Register, and a 1394 node.

As described above, by using any one of a register, a Plug Control Register, and a 1394 node as the network component, it is possible to reliably control availability/unavailability of the network component.

Yet further, a network relay device according to the present invention, in the above arrangement, may be arranged such that the first communications network is a communications network with which said device can transmit data after securing a communications resource, and the event and/or the state, regarding the first communications network, detected by the event/state detecting section is obtaining, change, or release of a communications resource in the first communications network, or a communications resource obtaining state, for data to be transferred between the first communications network and the second communications network.

In this arrangement, when the event/state detecting section detects obtaining, change, or release of a communications resource in the first communications network, obtaining, change, or release of a communications resource in the second communications network is carried out. This brings about the effect that communications resources in the first communications network and the second communications network can be obtained, changed or released in relation to each other.

Moreover, upon detection of obtaining, change, or release of a communications resource in the first communications network, it is possible to properly determine, from the detected content, the amount of resource required for data communications. This brings about the effect that it is possible to properly set a communications resource to be secured in the second communications network.

Further, a network relay device according to the present invention, in the above arrangement, may be arranged such that the event and/or the state, regarding the first communications network, detected by the event/state detecting section is reception or completed reception of data itself to be transferred from the first communications network to the second communications network.

In this arrangement, when the event/state detecting section detects reception or completed reception of data itself to be transferred from the first communications network to the second communications network, a resource in the second communications network is obtained, changed, or released. This allows for securing of a resource in the second communications network only when data flows to the second communications network, thus realizing an efficient use of a resource in the second communications network. Upon receipt of data transferred from the first communications network to the second communications network, it is possible to properly determine the amount of resource actually used for data communications, in view of size and reception time of the received data. This brings about the effect that it is possible to properly set a communications resource to be obtained, changed, or released in the second communications network.

Still further, a network relay device according to the present invention, in the above arrangement, may be arranged such that the communications resource determination section calculates a communications resource in the second communications network, on the basis of the amount of communications resource obtained by measurement of the data received from the first communications network.

In this arrangement, the communications resource determination section calculates a communications resource in the second communications network, on the basis of the amount of communications resource in the first communications network. This brings about the effect that it is possible to properly set a communications resource to be secured in the second communications network.

Yet further, a network relay device according to the present invention, in the above arrangement, may be arranged such that the first communications network is a communications network with which said device can transmit data after securing a communications resource, and the communications resource determination section calculates a communications resource in the second communications network, on the basis of a communications resource obtained, changed, or released in the first communications network.

In this arrangement, a communications resource to be secured in the second communications network is calculated on the basis of a communications resource obtained, changed or released in the first communications network. In view of obtaining, change, or release of a communications resource in the first communications network, it is possible to properly determine the amount of resource required for data communications. This brings about the effect that it is possible to properly set a communications resource to be secured in the second communications network.

Further, a network relay device according to the present invention may be arranged such that the communications resource determination section estimates a bandwidth of data transmitted through the communications resource obtained, changed, or released in the first communications network, and then calculates the communications resource in the second communications network on the basis of the estimated bandwidth.

In this arrangement, on the basis of information on a communications resource obtained, changed, or released in the first communications network, a bandwidth of data transmitted is estimated. Here, it is possible to perform a relatively accurate estimation of a bandwidth for data from information on communications resource. Then, a communications resource in the second communications network is calculated by using the bandwidth of this data. This brings about the effect that it is possible to more properly set a communications resource to be secured in the second communications network.

Still further, a network relay device according to the present invention may be arranged such that the communications resource determination section calculates the communications resource to be secured in the second communications network, with consideration of a property of the second communications network.

According to the above arrangement, the communications resource to be secured in the second communications network is calculated with consideration of a property of the second communications network. This brings about the effect that it is possible to properly secure a communications resource even when the reliability of communications varies in the second communications network, for example.

Yet further, a network relay device according to the present invention may be arranged such that the communications resource determination section calculates a communications resource to be secured in the second communications network, on the basis of (i) a communications resource required for normal data transmission in the second communications network and (ii) a communications resource required for data retransmission.

In this arrangement, the communications resource to be secured in the second communications network is calculated on the basis of (i) a communications resource required for normal data transmission and (ii) a communications resource required for data retransmission. That is, by giving a consideration to a communications resource required for data retransmission, securing of a communications resource is performed with proper consideration of communications environment in the second communications network. This brings about the effect that it is possible to realize a stable communications.

Further, a network relay device of the present invention may be arranged so as to further include a communications state detecting section for detecting a communications state in the second communications network, wherein: the communications resource management section changes the communications resource secured in the second communications network, in accordance with a change in communications state in the second communications network.

In this arrangement, a communications state in the second communications network is detected by the communications state detecting section, and a communications resource to be secured in the second communications network is changed in accordance with this detection result. This makes it possible to properly change a communications resource in accordance with variation in communications state in the second communications network. This brings about the effect that it is possible to realize more stable communications.

Still further, a network relay device according to the present invention may be arranged such that the communications state detecting section detects an error rate of data transmission in the second communications network, and if the error rate exceeds a given value, the communications resource management section increases a communications resource to be obtained in the second communications network.

In this arrangement, a communications resource to be obtained in the second communications network is changed in accordance with the error rate of data transmission in the second communications network. Knowing the error rate can properly grasp the extent to which data retransmission should be made, so that it is possible to more properly change the communications resource to be obtained in the second communications network. This brings about the effect that it is possible to realize more stable communications.

Yet further, a network relay device according to the present invention may be arranged such that the communications state detecting section detects a data communications time in the second communications network, and as a result of comparison between the data communications time and a time given by an already allocated communications resource, the communications resource management section changes the communications resource obtained in the second communications network.

In this arrangement, by comparing between a communications time for data transferred to the second communications network and a time given by an already allocated communications resource, the communications resource to be obtained in the second communications network is changed. That is, for example, if a communications time for data transferred to the second communications network is less than the time given by an already allocated communications resource, such a control of reducing a communications resource to be obtained in the second communications network becomes possible. This makes it possible to prevent such a state of securing the communications resource in vain. This brings about the effect that it is possible to realize the efficient use of a band.

Further, a network relay device according to the present invention, in the above arrangement, may be arranged such that the event/state detecting section receives information on network state from other communications device connected to the first network.

This arrangement brings about the effect that it is possible to detect the state of the first network at the time of reception of information on network state from other communications device.

Still further, a network relay device according to the present invention may be arranged such that the event/state detecting section requests information on network state to other communications device connected to the first network.

This arrangement brings about the effect that it is possible to detect a state of the first network at the time of an autonomous request of information on network state to other communications device.

Yet further, a network relay device according to the present invention may be arranged such that the event/state detecting section checks a network state in the first communications network at regular intervals.

In this arrangement, a network state in the first communications network is checked at regular intervals. This brings about the effect that it is possible to detect an unexpected cut-off of communications in the first communications network within a given period of time.

Further, a network relay device according to the present invention may be arranged such that the event/state detecting section checks a network state in the first communications network upon receipt of notification of a predetermined event from the first communications network.

According to the above arrangement, upon receipt of notification of a predetermined event from the first communications network, a network state in the first communications network is checked. Here, for example, in a case where a band in the first communications network is released when communications in the first communications network is unexpectedly cut off, this case is detected as an event, and a communications resource in the second communications network can be released at a timing substantially the same as the timing when communications in the first communications network have been cut off.

Still further, a network relay device according to the present invention, in the above arrangement, may be arranged such that the communications resource management section obtains, changes, or releases a communications resource in the second communications network, after a lapse of a given time from detection of a network state in the first communications network.

Here, examples of a detected network state include the occurrence of bus reset. In this arrangement, such a rule can be defined that an application having established a connection before a bus reset establishes the same connection within a given period of time after the bus reset occurs. Therefore, the above arrangement brings about the effect that it is possible to properly obtain, change, or release a communications resource after establishment of the same connection.

Yet further, a network relay device according to the present invention may be arranged such that the event/state detecting section detects, as a network state in the first communications network, presence or absence of other entity which communicates data with said device in the first communications network.

According to the above arrangement, upon detection of absence of a station at the other end of data communications with the network relay station in the first communications network, a communications resource in the second communications network is released. This brings about the effect that it is possible to reliably detect cut-off of communications in the first communications network and release a communications resource in the second communications network.

Further, a network relay device according to the present invention may be arranged such that the event/state detecting section detects, as a network state in the first communications network, a connection established state in the first communications network.

According to the above arrangement, by detection of a connection established state in the first communications network, it is determined whether a communications resource in the second communications network should be released. Therefore, if communications in the first communications network have been cut off, processing in the first communications network cuts off the communications concerned. This brings about the effect that by detecting cut-off of this connection, it is possible to release the corresponding communications resource in the second communications network.

Still further, a network relay device according to the present invention is arranged so as to include: a network component to which other communications station connected to the first communications network makes access so as to secure a communications resource on the first communications network; and a connection management section for controlling availability/unavailability of the network component.

According to the above arrangement, the connection management section controls availability/unavailability of the network component to which other communications station connected to the first communications network makes access so as to secure a communications resource on the first communications network. Here, on the network relay device side, the network component is set as being unavailable when a communications resource in the first communications network should be released. In this case, a communications station in communications through the first communications network gives up a connection recovery when the network component has become unavailable, since there exists no party at the other end. Therefore, the communications resource is released.

That is, according to the above arrangement, in the first communications network, even if it is defied such that only a communications station which has established a connection can cut off the connection concerned, the network relay devise can cut off this connection substantially. This brings about the effect that, for example, even when connection has been cut off on the second communications network, a connection in the first communications network is cut off, so that it is possible to release a communications resource.

Yet further, a network relay device according to the present invention, in the above arrangement, may be arranged such that the connection management section notifies change in availability/unavailability of the network component to said other communication station, or issues a trigger which notifies the change.

The above arrangement brings about the effect that the connection management section, after having made the network component unavailable, notifies unavailability of the network component to other communications station connected to the first network, thereby causing a quick execution and failure of a connection recovery in the first network and realizing release of a communications resource.

Further, a network relay device according to the present invention may be arranged such that the first communications network or the second communications network is in conformity with IEEE1394.

According to the above arrangement, the first communications network or the second communications network is in conformity with IEEE1394 having an isochronous transfer scheme where data that must be transferred at certain timings, such as voice and moving image, is transferred on a priority basis. This brings about the effect of an optimum communications of multimedia data and the like.

Further, a network relay device according to the present invention may be arranged such that the first communications network or the second communications network is a wireless network.

According to the above arrangement, the first communications network or the second communications network is a wireless network. This brings about the effect of realizing to establish such a system that a plurality of wired networks at distance from one another are connected through a wireless network.

Still further, a network relay device according to the present invention may be arranged such that the first communications network is in conformity with IEEE1394, and an event notified from the first communications network is a bus reset defined by the IEEE1394.

According to the above arrangement, upon receipt of notification of the bus reset defined in the IEEE1394, a network state in the first communications network is checked. This brings about the effect that by detecting the bus reset as an event, it is possible to release a communications resource in the second communications network at a timing substantially the same as a moment when communications on the first communications network is cut off.

Yet further, a network relay device according to the present invention may be arranged such that the first communications network is in conformity with IEEE1394, and as a resource obtaining state in the first communications network, used is a value of BANDWIDTH_AVAILABLE or CHANNELS_AVAILABLE register held by an Isochronous Resource Manager in the first communications network.

As described above, the use of a value of BANDWIDTH_AVAILABLE or CHANNELS_AVAILABLE register held by the Isochronous Resource Manager brings about the effect that it is possible to reliably detect the resource obtaining state.

Further, a network relay device according to the present invention may be arranged such that the first communications network is in conformity with IEEE1394, and as the connection established state in the first communications network, used is a connection counter value of a Plug Control Register held by a data transmitting station or data receiving station in the first communications network.

As described above, the use of a connection counter value of a Plug Control Register held by a data transmitting station or data receiving station in the first communications network brings about the effect that it is possible to reliably detect the connection established state.

Still further, a network relay device according to the present invention may be arranged such that the network component is any one of a register, a Plug Control Register, and a 1394 node.

This brings about the effect of allowing for a reliable control of availability/unavailability of the network component.

Further, a network relay program according to the present invention is a network relay program causing a computer to execute an operation of the network relay device according to the present invention.

This makes it possible to provide the foregoing network relay device to the user by loading the foregoing program into a computer system.

Still further, a storage medium containing the network relay program according to the present invention is arranged so as to contain a network relay program causing a computer to execute an operation of the network relay device according to the present invention.

This makes it possible to provide the foregoing network relay device to the user by loading a program contained in the storage medium into a computer system.

The present invention is not limited to the aforementioned embodiments and is susceptible of various changes within the scope of the accompanying claims. Also, an embodiment obtained by suitable combinations of technical means disclosed in the different embodiments are also included within the technical scope of the present invention.

Specific embodiments or examples implemented in the best mode for carrying out the invention only show technical features of the present invention and are not intended to limit the scope of the invention. Variations can be effected within the spirit of the present invention and the scope of the following claims.

### INDUSTRIAL APPLICABILITY

As described above, a network relay device according to the present invention makes it possible to establish a system where a plural types of networks are connected to one another, and can be applied as a network relay device in such a system that various AV devices respectively located in the rooms in a house, for example, are connected to one another through networks of different types.

1. A communication station connected with at least one network, wherein:
upon receipt of a communications resource obtaining trigger for a stream to be transmitted or received by the communication station,
the communication station determines whether the communication station transmits the stream in the network, and
the communication station, in accordance with a result of the determination, changes whether the communication station obtains a communications resource of the network from a communications resource management station.

2. The communication station according to claim 1, wherein the network has a limitation of a station capable of securing a communications resource.

3. The communication station according to claim 1, wherein the communication station is a relay station between two networks.

4. The communication station according to claim 3, wherein the communication station, upon receipt of the communications resource obtaining trigger, obtains a communications resource of that one of the two networks from which the communications resource obtaining trigger was notified, and then obtains a communications resource of the other one of the two networks to which the stream will be transmitted.

5. The communication station according to claim 1, wherein the communications resource is a band of the network connected to the communication station.

6. The communication station according to claim 1, wherein whether the communication station transmits or receives the stream with use of the communications resource is notified by the communications recourse obtaining trigger.

7. The communication station according to claim 1, wherein the communication station determines what station the communications resource management station is, and changes whether the communication station obtains the communications resource from the communications resource management station.

8. A method of communication using a communication station connected with at least one network, comprising the steps of:
receiving a communications resource obtaining trigger for a stream to be transmitted or received by the communication station;
determining whether the communication station transmits the stream in the network; and
in accordance with a result of the determination, changing whether the communication station obtains a communications resource of the network from a communications resource management station.
